(19) United States
(12) Patent Application Publication
(10) Pub. No.: US 2004/0221259 A1
(43) Pub. Date: Nov. 4, 2004

(54) Method and apparatus for status display with intermediate database access

(76) Inventors: Lyle E. Devore JR., Midlothian, TX (US); Steven Michael Sprague, Arlington, TX (US); Ryan Jaeger, Arlington, TX (US); John J. Varley, Orlando, FL (US); Jerome Aguirre Nicolas, Cedar Hill, TX (US); Richard Douglas Lampe, Orlando, FL (US); Billy Clark, Hillsboro, TX (US); Richard Allen Vaughn, Arlington, TX (US)

Correspondence Address: SIDLEY AUSTIN BROWN & WOOD LLP, 717 NORTH HARWOOD, SUITE 3400, DALLAS, TX, 75201, US

(21) Appl. No.: 10/674,127

(22) Filed: Sep. 29, 2003

Related U.S. Application Data
(63) Continuation-in-part of application No. 10/654,845, filed on Sep. 4, 2003.
(60) Provisional application No. 60/466,971, filed on May 1, 2003.

(51) Int. Cl. G06F 9/44

(52) U.S. Cl. 717/102; 717/105

(57) ABSTRACT

A system and method for information display based on a family of display screens for displaying information derived from numerous data sources including intermediate datasources. Each display screen includes function controls as well as indicator controls. The function controls link a first level display screen to subsidiary display screens. A capacity is provided for saving defined display screen formats and for generating a custom display screen based on function controls which were previously defined in defined display screens. Also disclosed is a method of using a family of display screens for managing access to information and displaying that information.

### RELATED APPLICATION

The present application is related to and claims priority from provisional application serial No. 60/466,971, filed May 1, 2003, the entire contents of which are incorporated herein by reference. The present application is a continuation-in-part of U.S. patent application Ser. No. 10/654,845, filed Sep. 4, 2003.

### FIELD OF THE INVENTION

The present invention relates to an apparatus for data management and a method of creating and using a data management system to access data relating to one or more tasks.

### BACKGROUND OF THE INVENTION

With the advent of the wide spread use of computers, a wide variety of data sources have developed in a relatively short amount of time. Traditional legacy mainframe system are still utilized for the core processing power of many organizations. However, these data sources have now become islands of information that while they are related to other data sources the existing systems provide little or no ability to communicate with each other. Corporations today find that enterprise level solutions are burdensome for the average user and the challenge of empowering individuals with real time data for their individual responsibilities is overwhelming in both cost and magnitude based upon ever changing requirements. Moreover, these legacy systems may be physically separated by thousands of miles or practically separated based upon incompatible programming languages, which makes sharing of data difficult to accomplish.

Recently, several products such as ColdFusion, by Macromedia, have introduced advanced data access tools which provide a common means to access data across great numbers and types of data sources. These tools, while addressing the problem of accessing data across many sources, ultimately only exacerbate the data overflow problem faced by today's businesses; too much information and insufficient analysis capability to make sense of the information.

Thus, in spite of the improved computer and software tools which can access the diverse variety of data sources, there remains an unmet need for information analysis and presentation tools which allow rapid access to diverse data and which can analyze, correlate and present the data to multiple types of users in a business organization in a manner effective for each user type. There also remains an unmet need for an information analysis and presentation tool which can be easily customized by each user without knowledge of either computer programming languages or the multiple database applications on which the data is stored. There also remains an unmet need for a business intelligence system which can rapidly prototype information reporting and analysis.

### SUMMARY OF THE INVENTION

The present invention addresses the aforesaid unmet needs by providing a system and method for information display based on a family of display screens for displaying information derived from numerous data sources. Throughout the following description of the present invention and of the preferred embodiments thereof, the terms “display” “dash” “digital dash” and “screen” may be used interchangeably in related context. As generally used, the term refers to a graphical and/or textural (e.g., alphanumeric) display screen to portray information for a user.

In one embodiment, the present invention is a web-based concept that gives end users the ability to access multiple data sources from a single location in an intuitive and easy-to-use graphical and textual format. The data is preferably presented “real time” or near real-time in a process-oriented fashion mimicking the flow of actual data and/or hardware. “Real time” may be the latest data available for the most effective analysis and reporting, whether the data is updated monthly, weekly, daily, or hourly. Drill-down capabilities give the end user the ability to view data from a top-level perspective all the way down to the fine details. Making the application web-based gives the user the ability to access the data from any location with network access either within the firewall or with special access through the firewall. In addition, the end user's credentials (e.g., NT login) optionally controls access to restricted folders and data.

One aspect of the present invention includes the ability to quickly create useful dash applications that allow the user to immediately see the power, value, and potential of their custom dash. Such rapid prototyping can serve as a catalyst in identifying better ways of visualizing, tracking, and analyzing other critical processes. Ideally, customer requirements would be clearly defined and an application developed in accordance with these requirements. The application could be built in relatively short time and thereby quickly producing valuable results for the customer. However, large organizations with competing priorities can take a significantly long time in providing specific requirements, especially when dealing with new concepts and methods such as the present idea of collecting and centralizing critical process information. In such a case the instant rapid prototyping concept becomes an important tool.

A dash built according to the instant rapid prototyping concept would be built contrary to the typical Information Technology waterfall systems design method in which substantially all customer requirements are mapped out in advance of programming. In contrast, in the absence of well-defined customer requirements, the instant rapid prototyping concept emphasizes prototyping for rapid creation of a minimally functional deliverable. The technique includes the step of making one component work as a proof of concept, such as displaying data drawn from Access databases or Excel files, etc. Once an initial capability is achieved, the customer can refine the system, critique the application, and elaborate their wants and requirements. After that, the programmer can then expand or widen the functionality based on the customers' needs.

Thereafter, once the application is running, and the customer is satisfied with the results, the data needs to be migrated from a development environment to production. For rapid prototyping efforts that may have utilized simplified data structures, such data could be migrated to a more stable data platform in a production environment. More robust database platforms, such as Oracle, and Enterprise Folders, that are in line with IT's mission statement, can be used to migrate the system from a prototyping environment to a production environment. Additionally, this keeps the application in line with future technologies.

According to preferred embodiments of the present invention, data sources, reports, and user interfaces would be designed in such a way that the same application and data can be used by other organizations. To this end, data, data sources, application files, and associated information should be accessible to end users and developers and easily modified to meet the specific needs of a functional area or program. For example: Quality Assurance (QA) created a training report for its personnel that could also be used to build a similar report for Product Operations (Prod Ops). By structuring the data and query to allow searching for a “QA” identifier within the training database, rather than using a lengthy hard-coded list of all QA unit numbers, the QA training report could be customized for Prod Ops simply by changing a single query criteria from “QA” to “PROD OPS”.

Similarly, according to preferred embodiments of the present invention, data and web pages called from one business domain should be designed such that the same data and web pages can be called from a different business domain. Public data (data that may be viewed by the general employee population) would be utilized as much as possible in order to realize the full potential of the system. However, sensitive data may be included as long as appropriate measures are taken to restrict access. Such data is preferably not expected to be available to other end users or developers.

In a preferred embodiment, a dash is a system comprising a main graphical interface and its associated files and reporting applications. In general, a preferred implementation of a dash would include an embedded collection of program links, URL links, query links as well as possibly links to other dashes. Preferably, a main graphical component would be used to give the dash a unique look and feel and provide end users with an intuitive, easy to use interface. Prototype implementations of a dash screen have been produced with Macromedia Flash. In these prototype implementations, the Flash object is then embedded within a ColdFusion file. Preferably, buttons and status indicators that appear on the dash screen are set using information contained within a database which maintains a record of the settings and other configuration information relating to the dash screen. The database can be updated to change button labels, status and hyperlinks.

Also in a preferred embodiment, the buttons on the dash can link to virtually any electronic file format (including, without limitation, MS Word file, PowerPoint presentation, Excel spreadsheet, HTML page, ColdFusion application, etc.). Moreover, the buttons on the dash can link to functions, applications, JAVA applications, scripts, etc., as well as to another dash. The business area that is utilizing the dash will determine which files or applications will be referenced by the main dash screen. Because the configuration of the dash is customizable and reconfigurable, new files or applications can be created as needed and added as new buttons to the dash.

Also in a preferred embodiment, an intermediate database can be employed between the databases associated with native applications and the dash display system. The intermediate database provides numerous benefits including the ability to provide universal translation capability between database types the dash system, as well as security benefits, and ease of implementation benefits. Also, use of an intermediate database can greatly facilitate rapid prototyping of operational dash displays.

Also in a preferred embodiment, a multidimensional scorecard can be generated as part of the dash system to display relationships between different parameters such as quality and delivery.

Preferably, a series of applications and custom dashes are developed to address specific data and reporting needs of an organization. Alternatively, applications and custom dashes are developed to address specific data and reporting needs of specific functional groups within a larger organization. By implementing a system of dashes, an entire organization can be provided with timely, near real-time, at-a-glance, access to its critical business information. Each individual within an organization or segment of the business can customize their dash to represent their individual responsibilities.

### BRIEF DESCRIPTION OF THE DRAWINGS

A more complete understanding of the present invention and its advantages will be readily apparent from the following Detailed Description taken in conjunction with the accompanying drawings wherein like parts are designated by like reference numbers and in which:

FIG. 1 is a schematic illustration of a computer network environment suitable for the deployment of the present invention;

FIG. 2 illustrates an embodiment of a user interface dash in accordance with the present invention;

FIGS. 3A-3B illustrate an embodiment of a dash configured to report quality information in accordance with the present invention;

FIGS. 3C-3D illustrate embodiments of reports accessible via a dash in accordance with the present invention;

FIG. 3E illustrates an embodiment of a database application screen accessible via a dash in accordance with the present invention;

FIG. 4A illustrates an embodiment of a dash for reporting human resources information in accordance with the present invention;

FIGS. 4B-4C illustrate embodiments of reports accessible via the dash;

FIG. 5 illustrates a series of dashes that can be adapted for use by a user in accordance with the present invention;

FIG. 6A illustrates an embodiment of a dash and an associated database definition in accordance with the present invention;

FIG. 6B illustrates a series of dashes and associated database definitions in accordance with the present invention;

FIG. 7A-7C illustrate an embodiment of a dash template for creating a custom dash in accordance with the present invention;

FIG. 7D illustrates a plurality of display dashes which share link or query button definitions in accordance with the present invention;

FIG. 8 illustrates an embodiment of a dash for providing three-dimensional data in accordance with the present invention;

FIG. 9 illustrates an embodiment of a computer network environment suitable for creating and using a dash in accordance with the present invention.

FIG. 10A illustrates a conceptual relationship between the dash display, detailed data displays and the underlying databases;

FIG. 10B illustrates a conceptual relationship between the dash display, detailed data displays and underlying databases including an intermediate database; and

FIG. 11 illustrates a scorecard display in accordance with an embodiment of the present invention.

### DETAILED DESCRIPTION OF THE PREFERRED EMBODIMENTS

Various embodiments of the present invention are described in detail with reference to the drawings. In the following description, numerous specific details are set forth in order to provide a more thorough description of the present invention. It will be apparent, however, to one skilled in the art, that the present invention may be practiced without these specific details. In other instances, well-known features have not been described as their capabilities are well within the knowledge of one having ordinary skill in the art.

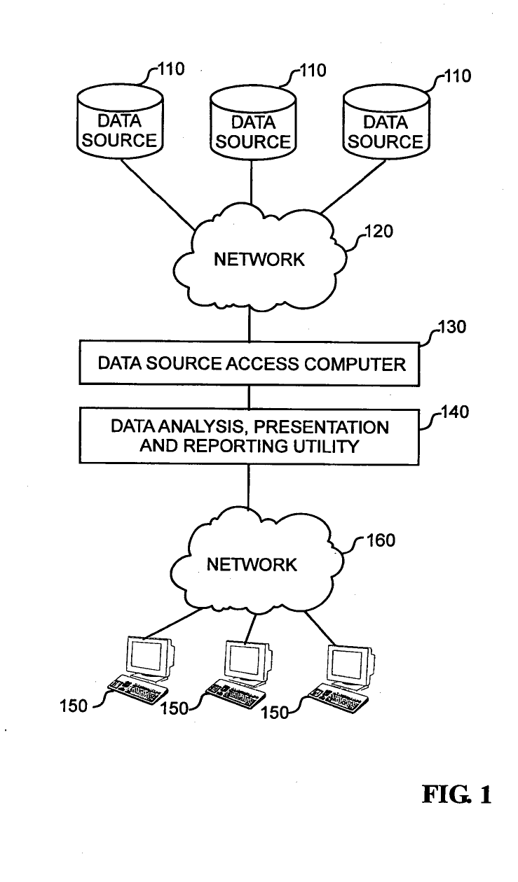

FIG. 1 schematically illustrates a computer network environment suitable for the deployment of the present invention. FIG. 1 shows a series of data sources 110 which are connected via an optional network 120 to a data source access computer 130 which provides universal data source accessibility. The data source access computer 130 is interfaced with a data analysis, presentation and reporting utility 140 which can be optionally on a same computing platform or on a different computing platform than the data source access computer 130. Information from the data analysis, presentation and reporting utility 140 can be accessed by a plurality of user terminals 150 via optional network 160. As will be understood by people of ordinary skill in the art, networks 120 and 160 can be separate networks or alternatively can be the same network and can be, for instance, a private or public network such as a common Ethernet, internet, intranet computer network system, wireless network or other electronic system.

Specific details of the data sources 110 is omitted from this discussion for the sake of brevity. However it is sufficient to say that all manner of data sources are contemplated as usable with the present invention including, for example, SAP databases, Oracle databases, flat file databases, SQL databases, XML databases, and Btrieve databases. Of course, any data source beyond databases may also be used without limitation, such as Computer-Aided Design (CAD), Excel, Powerpoint and TIF data sources. Moreover, data sources are not limited to file or database type sources. The data sources may also include streaming data provided, for example, by a sensor or process control system. The foregoing list is by way of illustration and not by way of limitation. One of ordinary skill will also understand that commercially available software utilities are presently available for providing cross platform and cross database access capabilities. Examples of these commercially available products include WebFocus and ColdFusion. Specific details of WebFocus and ColdFusion are omitted from this discussion for the sake of brevity.

Also referring to FIG. 1, it will be appreciated that the user computers 150 are employed for the purpose of presenting data taken from data sources 110 and presented directly or by way of processing through data source access computer 130 and data analysis, presentation and reporting utility 140 for display to a user. The user computers 150 can be any type of currently known or later developed user interface device including without limitation, desktop PC, notebook PC, thin client appliance, handheld device, wireless device, cell phone, PDA, etc. As a further example, on a shop floor, a projection device can be used to provide data to a plurality of users. Again the foregoing list of exemplary user computers 150 is provided by way of illustration and not by way of limitation. Similarly, one of ordinary skill will understand that data source access computer 130 and data analysis, presentation and reporting utility 140 may operate on a single computer or a cluster of computers and can be a computer for directly interfacing with a client or, alternatively, can be a server to serve the output of a process to a client computer (such as user computer 150). Still further by way of example, data analysis, presentation and reporting utility 140 can be a web server computer which serves the output of its processing to a web client computer (such as user computer 150). Finally, it will be appreciated that the user computers 150 can be directly connected to the data analysis, presentation and reporting utility 140. Alternatively, the user computer 150 can be indirectly connected to the data analysis, presentation and reporting utility 140 via a private or public network, or may be wirelessly connected through all manner of known and future developed wireless access protocols.

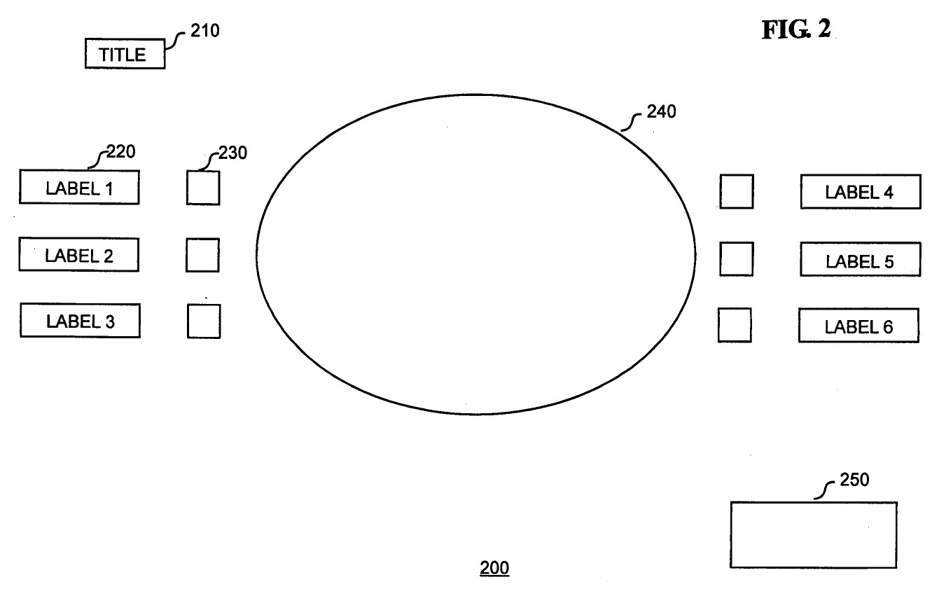

FIG. 2 generally illustrates a user interface dash 200. A dash 200 is any variety of user interface screen for displaying information. A dash may be an application generated graphic image, such as would be generated by any number of programs, including C, C++, visual C++, ColdFusion, etc., or it may be a passive or interactive HTML, XML, etc., screen displayed on a browser. As shown in FIG. 2, dash 200 includes a field for a title 210, a plurality of fields for labels 220 and, for each label 220, an associated field for an indicator 230. Dash 200 also includes a central display region 240 for the presentation of generated information to the user. Any selection device, such as a mouse, pointer, touch screen, voice recognition, etc., can be used as an interface to the dash 200. As will be appreciated, the particular layout of the title 210, labels 220, indicators 230, and central display region 240 may be varied based on a particular users' needs or subjective preferences.

As will be explained more fully below, each label 220 optionally includes the capability of a built-in function which can be invoked when the label 220 is selected. For example, when dash 200 is displayed on a user terminal (such as user computer 150), a user may move their mouse to label 220 and activate that label (e.g., by clicking their mouse) to invoke a function associated with the label 220. Also as explained more fully below, indicators 230 can be configured to quickly illustrate a status of information associated with the corresponding label 220. Dash 200 additionally includes an optional function box 250 which can be used for any purpose including, for example, invocation of a so-called suggestion box function. The suggestion box 250 may be used, for example to allow a user to submit recommendations or requests for enhancements, modifications, changes, maintenance, or upgrades to, for example, the data source access computer 130, the data analysis, presentation and reporting utility 140 or the dash 200.

In one aspect of the invention, a user computer 150 can access the data analysis, presentation and reporting utility 140 and view the dash 200 by use of an internet or intranet. The user computer 150 can, for example, employ a web browser and access the dash 200 by using a universal resource locator (URL). Thus, the user computer 150 need not be physically located near the utility 140 or the data sources 110. Alternatively, the user computer 150 can access the utility 140 via other public or private communications protocols.

In one embodiment, the dash 200 can provide centralized access to (preferably) real-time or periodic information using a web-browser interface. By providing a centralized access point to multiple data sources, the dash can reduce or eliminate the need for multiple logins and multiple passwords (which may be required for accessing each individual data source). Of course, the need for logins and passwords may vary depending on security requirements for the data (or facility) in question.

Further, the dash 200 can provide a user-friendly environment where a working knowledge of vastly different computer applications and systems may be made unnecessary. The reporting utility 140 can, via the dash 200, advantageously allow critical data, such as financial data, performance metrics, process information, technical specifications, historical documentation, etc. to be brought together for processing, monitoring, and/or analysis. Calculations, filters, sorting or other processing can be performed on the data by the data analysis, presentation and reporting utility 140. Thus, the data can be processed in such a way as to make the data that is presented on the dash 200 easier to read and comprehend.

In one embodiment, the information can be tailored to the specific needs of an organization and can be organized in such a way that it can be easily accessed and analyzed. By collecting data from various data sources 110 and presenting it via the dash 200, the amount of time an individual manager typically spends in collecting data from a variety of systems and sources can be reduced. One embodiment of the present invention advantageously provides for processes to be monitored and metrics to be analyzed in real-time or near real time. The data can then be presented in a format that is easily understood and analyzed. In such an embodiment, the critical data requirements are determined. Access to such data can be automated and the data made available to users. The users can make decisions based on the data, which is now more quickly or easily accessible. Time previously spent locating and accessing data can now be spent on other value added tasks. Thus, the company as a whole becomes more productive by the power of data.

In one aspect of the invention, the dash 200 can be quickly developed and implemented for an individual user. The user can thus quickly see the power, value and potential of their dash 200. Better ways of visualizing, tracking and analyzing information and processes can be developed for the user based on their particular requirements or the requirements of their job. In one embodiment, requirements can be clearly defined and the application developed based on the requirements. In another embodiment, the development process can be an iterative process, wherein the developer can discuss the user's requirements and based thereon, quickly create a prototype dash. The user can view the prototype dash and request any modifications thereto, which can then be performed by the developer. This process advantageously provides the user the ability to comment on the dash as it is being developed, thereby increasing the user's satisfaction and ownership of the user's custom dash.

Indicator 230 preferably can be configured to quickly illustrate a status of information associated with the corresponding label 220. In other words, if label 220 corresponds to a function for displaying sales volume, then indicator 230 may be programmed with an underlying function to monitor, in real-time or near real time, sales volume and compare that monitored value with a threshold (such as a budget or forecast). When the monitored value is below, equal to, or above the threshold, a visual attribute of the indicator (for example, without limitation, color, appearance, blink, blink rate, symbol, bold, etc.) is preferably changed to provide a rapidly noticeable indication of the status of the monitored information in relation to that threshold. Of course, as discussed more fully below, indicator changes can be binary or multi-level.

Preferably, indicator 230 can be selected from a group of possible indicators. By way of example and not by way of limitation, a green sphere icon can be used to indicate that the metric associated with the corresponding label is within a desired range. A red octagon icon can be used to indicate that the metric associated with the corresponding label exceeds a desired range. A yellow triangle icon can be used to indicate a warning, for example, that the metric associated with the corresponding label is in danger of exceeding a desired range. An icon of a white “i” on a blue background can be used to indicate that additional information is available. In a preferred embodiment, the indicators can have different shapes, in addition to different colors. Thus, the indicators will be useful to a person who is color-blind.

Other styles of indicators can readily be created based upon the type of information desired. For example, a single dollar sign “$” could be used to denote a task is within cost, two dollar signs “$$” could be used to denote a minor task cost overrun, while three dollar signs “$$$” could be used to denote a significant cost overrun. Alternatively, the dollar sign indicators could be used to denote sales or profitability. For example, “$” could be used to denote a low level of sales or profitability, “$$” could be used to denote a moderate level of sales or profitability, while “$$$” could be used to denote a high level of sales or profitability. By knowing which products are selling rapidly, for example, a manager can ensure that an adequate supply of the product is ordered or, alternatively, in a manufacturing setting, that all the required raw materials are ordered, so as to maximize profitability.

In a related embodiment, an indicator can be animated. For example, a red octagon indicator can be made to flash or rotate to draw attention. In another embodiment, an indicator can include an upward pointing arrow to denote that a task is ahead of schedule or a downward pointing arrow to denote that the task is behind schedule. An upward pointing arrow can also be used to denote an increasing trend (e.g., increasing yield over time), a downward pointing arrow can be used to denote a decreasing trend (e.g., decreasing yield over time), while a horizontal arrow can be used to denote a little to no change in the trend (e.g., the yield level is substantially stable). A combination of two indicator icons could also be used. For example, a red octagon with an upward arrow may indicate that a task is behind schedule, but improving. Each indicator could be animated to show status and whether the situation is improving, remaining the same, or becoming worse. This could be accomplished, for example, by making the red octagon rotate in a downward direction in the event that the yield is unsatisfactory and becoming worse based upon a predetermined time frame.

In one embodiment, the selection of an indicator 230 for a particular label 220 is based on a tolerance associated with a metric corresponding to the label 220. For example, if the label 220 is “planned cost schedule,” a tolerance of 10% of the planned cost schedule may be selected. If, for example, the actual cost schedule varies from the planned cost schedule, an appropriate indicator can be set to display. In one embodiment, indicators for indicating a desired range (green sphere), warning (yellow triangle), and exceeding a desired range (red octagon) are all associated with a particular label (e.g., the planned cost schedule label). If, for instance, a task is within a few percent of the planned cost schedule, the green sphere indicator is active and visible. If the task is close to the 10% tolerance level, the yellow triangle indicator becomes active and visible, while the green sphere indicator becomes inactive. If the task is at or above the 10% tolerance level, the red octagon indicator becomes active, while the yellow triangle indicator becomes inactive. In the above example, the data source access computer 130 can access the appropriate data source(s) 110 and retrieve information pertaining to the actual cost schedule and the planned cost schedule. The data reporting, presentation and reporting utility 140 can then compare a difference between the actual cost and the planned cost to the tolerance level (which can be set by selecting a parameter associated with the label 220). Based on the relationship between the actual data and the tolerance level, the utility 140 can activate the appropriate indicator 230.

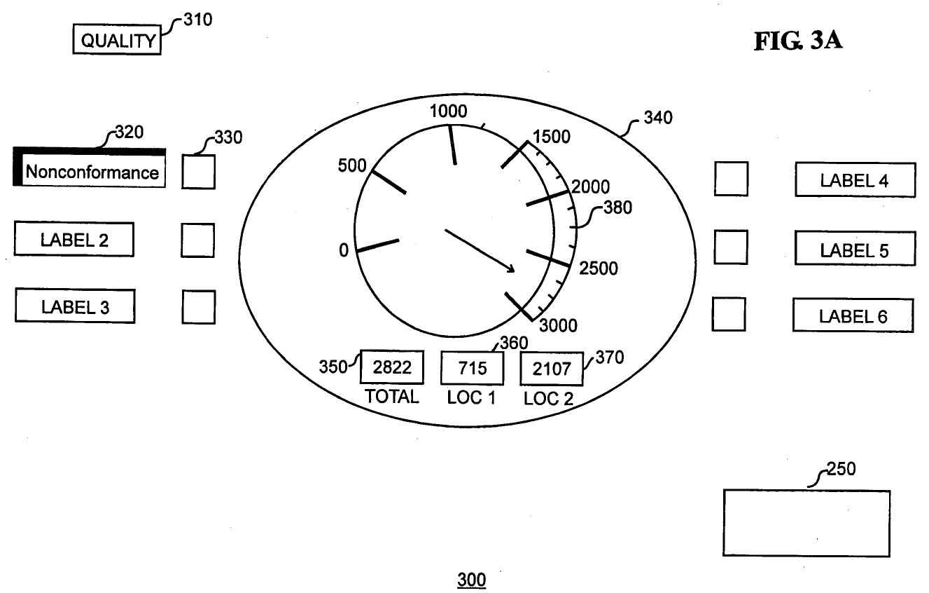

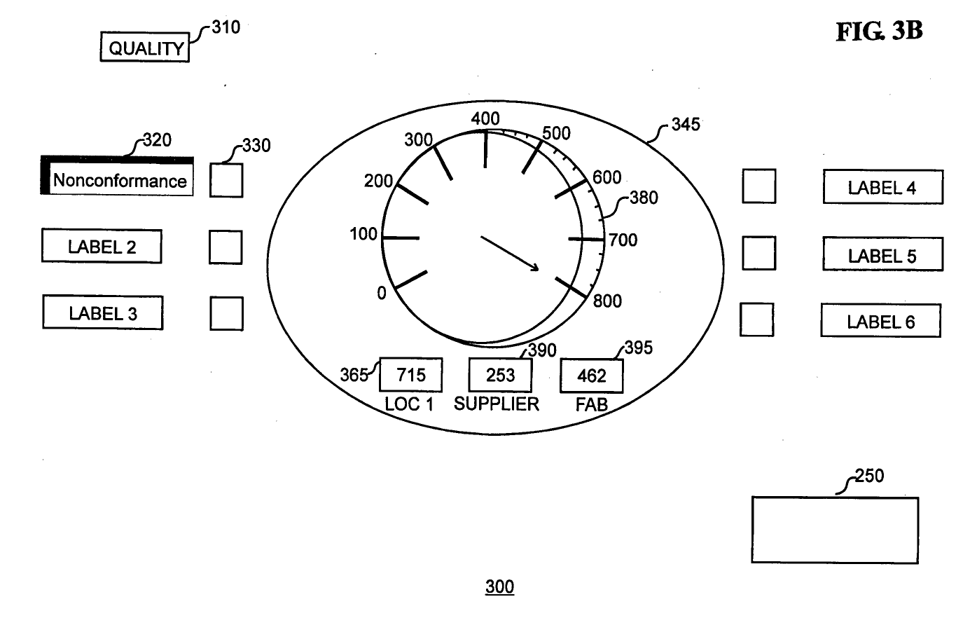

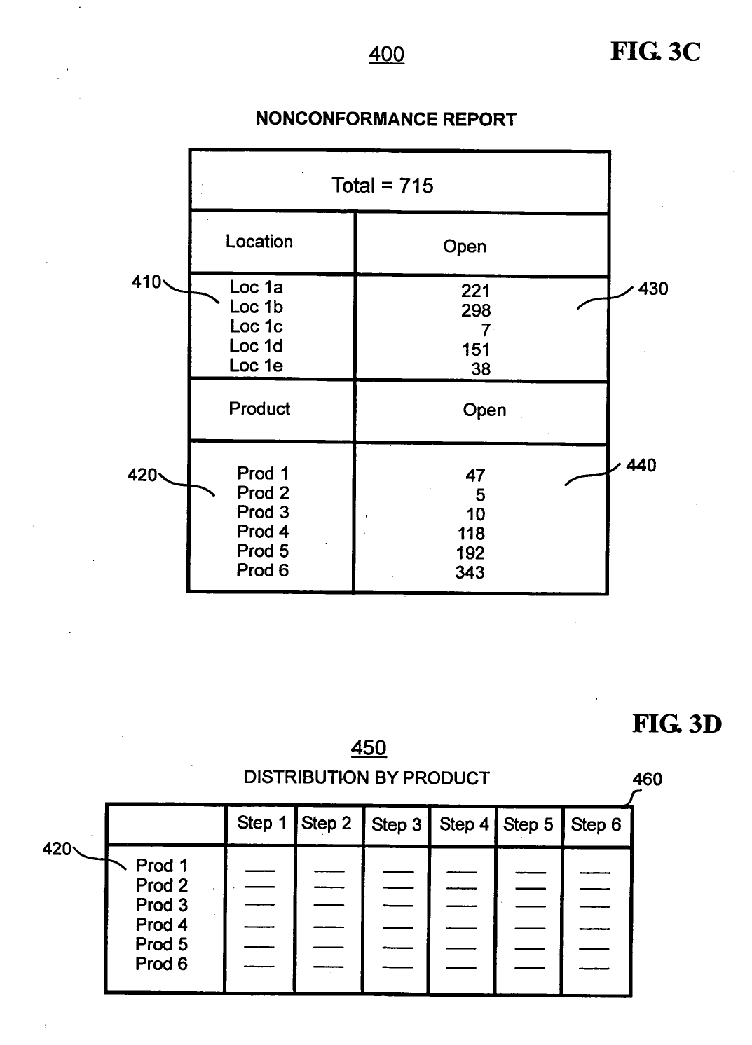

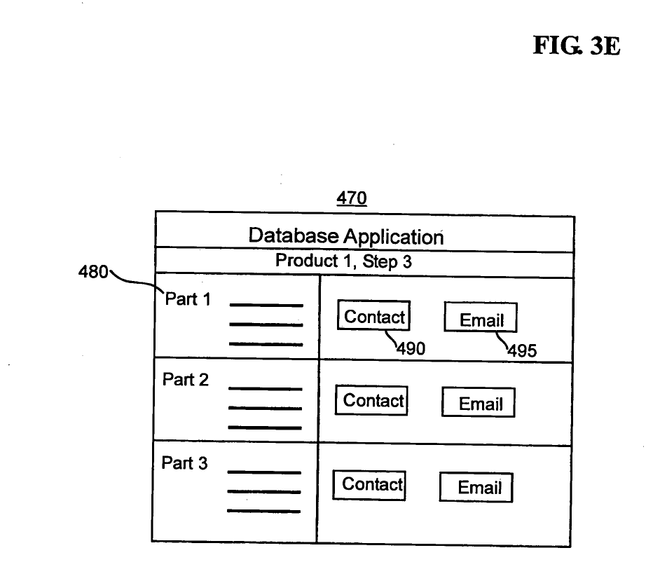

FIG. 3A generally illustrates an example of a particular embodiment of a dash 300 which has been configured to report quality information. As shown in FIG. 3A, title field 310 shows a particular title for dash 300. Similarly, label 320 now indicates a particular subject area, “nonconformance” for that label. Indicator 330 indicates a status corresponding to the label 320. As will be appreciated, dash 300, because it is for presenting quality information, may be used to track a number of parameters relating to a business' quality. Therefore, in addition to nonconformance, which is shown on label 320, other quality related parameters may be shown on the other labels, such as product yield, scrap rates, calibration, supplier information, and software quality. The foregoing list of quality parameters is by way of example and not by way of limitation.

FIG. 3A also shows a particular central display 340 which is invoked when nonconformance label 320 is activated. Specifically, when a user selects or activates nonconformance label 320, a predetermined function is invoked to generate a particular display of information associated with the subject of nonconformance. For example, as shown in FIG. 3A, nonconformance information may include a total amount of nonconformance 350, a Location 1 indicator of nonconformance 360, and a Location 2 indicator of nonconformance 370.

Moreover, and preferably, a graphical indicator of this parameter (e.g., total nonconformance 350) may also be shown, such as dial indicator 380. Although dial indicator 380 is an optional aspect of the preferred embodiment, it is a desirable aspect because such graphical illustration allows a user to rapidly assess an overall level of measurement (e.g., nonconformance), and may include indicated thresholds which can quickly and visually be perceived.

As will be understood, indicators 350, 360, 370 and graphical indicator 380 portray information obtained from one or more data sources, which are not shown in FIG. 3A. For example, indicator 350 shows that a quantity of 2822 nonconforming components exists in total. Of these, a total of 715 nonconforming components are at Location 1 as shown in indicator 360, and a total of 2107 nonconforming components are at Location 2 as shown in indicator 370. Central display 340 with the particular nonconformance information illustrated in FIG. 3A is automatically generated when nonconformance label 320 is selected. The particular techniques for accessing one or more databases and for associating particular data with a particular label will be discussed later in this specification. The user or organization could choose from a list of examples of how they want the dash to appear on their visual device (user computer or display device). Another user could decide that the same data should be represented on their visual display in another format. For example, a first user might prefer the data be in the form of a bar graph, while a second user might prefer the data in the form of a pie chart.

An optional but desirable aspect of the present embodiment of the invention includes the ability to select an indicator, such as indicator 360, and associate with that indicator a link to additional levels of details supporting an indicated value. For example, in the event that a user selects indicator 360 on FIG. 3A, the central display 340 would change to reflect new information. This situation is illustrated in FIG. 3B. Specifically, as shown in FIG. 3B, after indicator 360 has been selected, a new central display 345 is generated which provides a new level of information underlying the data associated with Location 1. For example, central display 345 now shows an indicator 365 portraying the same Location 1 nonconformance information but also shows indicators 390 and 395 which provide the underlying detailed data. For example, indicator 390 may illustrate the portion of nonconformance data associated with components obtained from suppliers, while indicator 395 may show nonconformance components obtained by internal fabrication.

Just as an indicator shown on central display 340 could be selected on FIG. 3A, and an additional level of information be obtained (such as revised central display 345), information presented on central display 345 may also link to additional levels of detail. As shown in FIG. 3C, when a user selects indicator 365 from FIG. 3B, a nonconformance report 400 is presented. Nonconformance report 400 can take any format which is suitable for the business organization. As shown in FIG. 3C, nonconformance report 400 may optionally break down the total nonconformance quantity by categories such as location or product. As shown on nonconformance report 400, because this report was obtained by clicking on indicator 365 which is associated with Location 1, all information on this report is associated with Location 1. However, nonconformance report 400 may subdivide Location 1 into smaller regions or sub-locations 410 such as Location 1A, Location 1B, etc. To provide a more concrete example, hypothetically speaking, overall nonconformance could relate to the entire geographic United States. Following this hypothetical, Location 1 associated with indicator 365 could be associated with one state such as Texas. Finally, continuing with this example, individual sub-locations 410 such as shown on nonconformance report 400, could be associated with specific cities or manufacturing sites in Texas. Along the same lines, nonconformance report 400 also illustrates nonconformance information segregated by products 420. Finally, nonconformance report 400 may also provide further levels of detail about nonconforming items such as whether the item is still in an open status 430 and 440.

Of course, what is particularly important to appreciate about FIGS. 3A through 3C is not the particular format of the reports, but instead that at each level of the display, summary information is portrayed and a link is provided to one or more additional levels of detail to assist the user (if necessary) in comprehending the significance or supporting factors for that information.

The concept of linking between levels of information is further illustrated in FIG. 3D. Just as a user could select indicator 365 on FIG. 3B and that selection would cause nonconformance report 400 to be presented (FIG. 3C), a user may similarly select a sub-location 410 from nonconformance report 400 and cause a distribution by product report 450 to be presented for that particular sub-location 410. Distribution by product report 450 may show, for example, a yet additional level of data resolution supporting the previously indicated information. More concretely, distribution by product report 450 can show products 420 for a particular sub-location 410 but now additionally can show how nonconformance information is collected according to steps in a manufacturing process 460.

Finally, a data item illustrated on distribution by product report 450 may be selected to link to a still further level of information. For example, selection of a particular step 460 in FIG. 3D may link a user directly to the native database application 470 historically used to manage data in a particular data source. Since the dash 300 ultimately links to the data in the native database application 470, changes to the information in the native database application 470 (e.g., new manufacturing data becomes available) may result in an update to the information displayed in central displays 340, 350. In one embodiment, the dash 300 is continuously updating. In such an embodiment, as new information is added to the native database application 470, the information displayed by dash 300 can be instantaneously updated. In an alternative embodiment, the dash 300 can retrieve data from the native database application 470 at a predetermined periodic interval, or can include a means for a user to refresh the data displayed with current data.

At the level of detail illustrated in FIG. 3E, detailed manufacturing data may be collected. Database application screen 470 may show individual manufacturing parts 480 and for each part a responsible party 490 may be tracked. Because the embodiments of the present invention employ cross database application capabilities, a facility such as e-mail or pager notification may be embedded in the user interface. For example, as shown in FIG. 3E, part 480 having responsible party 490 may include an e-mail hyperlink 495 to automatically generate an e-mail to the responsible party 490 should a question, comment or alert be desired to be manually transmitted. Additionally or alternatively, other methods of notifying the responsible party 490 can be provided, including notification via telephone, pager or other electronic means.

Of course, although not specifically illustrated in FIG. 3E, the system may be configured to monitor quantity of nonconformance levels and to automatically take action when a particular threshold level is achieved. This aspect of the present invention is discussed more completely in the following; however, in the context of e-mail notification, when a parameter reaches or exceeds a threshold it is also an aspect of the present embodiment that automatic e-mail notification or pager notification may be enabled. Other means of notifying the responsible party 490, whether manually, by selecting a link, or automatically upon reaching a predetermined threshold, can be provided. For example, the responsible party 490 can be notified via telephone, pager or other electronic notification system.

FIGS. 3A through 3E illustrate a particular functional area in a hypothetical company. These figures discuss, among other things, so-called nonconformance data, which is manufacturing part information relating to components having a nonconforming parameter or defect. The particular reports illustrated can be adapted for any type of underlying information and for any parameter that can be tracked for an organization. The particular reports illustrated in FIG. 3C through 3E are exemplary and not by way of limitation.

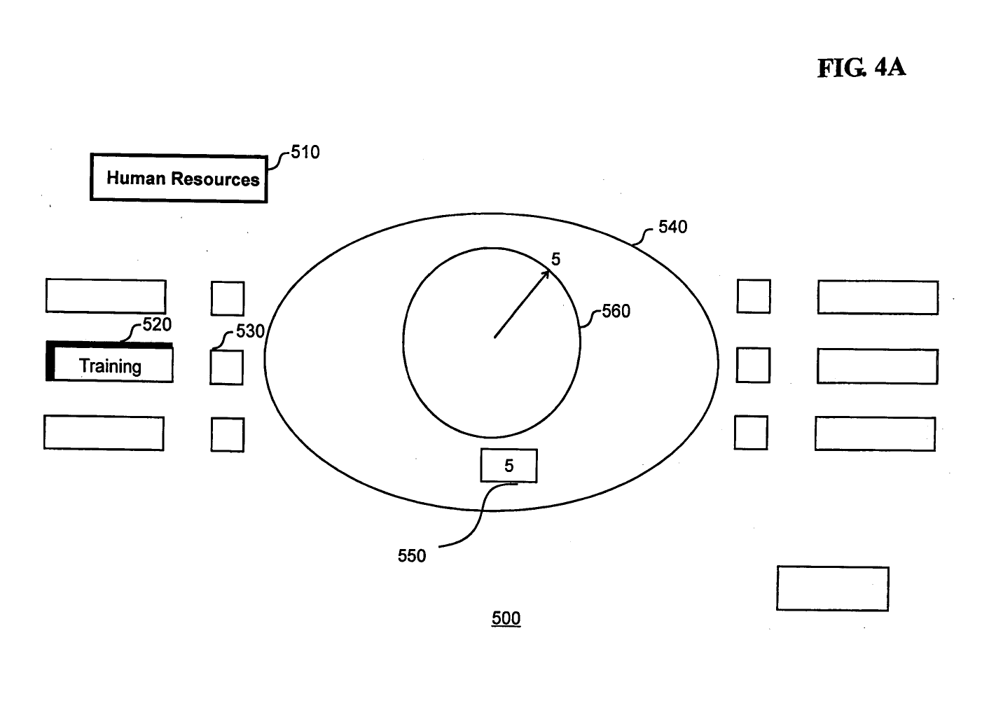

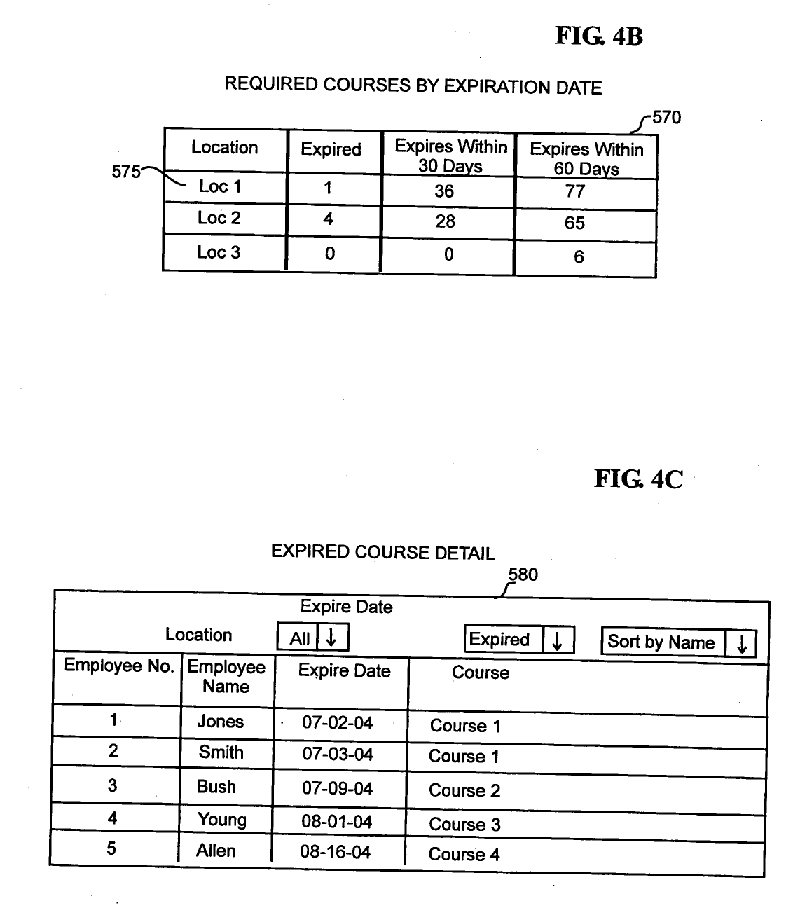

Just as FIGS. 3A through 3E illustrate a reporting and hierarchical data sequence for nonconformance information in the context of a manufacturing organization, the present embodiment can also report non-manufacturing information. For example, as illustrated in FIG. 4A, dash 500 can be used to present information relating to, for example, human resources information. As seen in FIG. 4A, dash 500 is adapted for human resources reporting and includes a title field 510 indicating that the dash is for human resources, a plurality of labels 520 specifically labeled and enabled to provide human resources related information, indicators 530 for indicating a status of the associated information, and a central display 540 for displaying a reported metric.

More specifically, as shown in FIG. 4A, when a training label 520 is selected on dash 500, central display 540 presents indicator 550, which is a measurement of the number of persons having expired training obligations, and graphical indicator 560, which provides a graphical depiction of the same information. In a manner similar to that described in the manufacturing example, when a user selects indicator 550 on dash 500, a next level of information linked thereto is presented. Specifically, as shown in FIG. 4B, when indicator 550 is selected, a required courses by expiration date report 570 is presented. The particular information arrangement and format of the required courses by expiration date report 570 is not critical to the present embodiment. However, the information shown on the required courses by expiration date report 570 comprise the component data values which were employed to report the value shown on indicator 550 and graphical indicator 560. For example, as shown on FIG. 4A, indicator 550 shows five persons having expired training courses. The required courses by expiration date report 570, as shown in FIG. 4B, breaks down the total of five persons by location. Additionally, other information such as, for example, calendar information about the expired course(s) may be presented.

Also in a manner similar to the manufacturing example, the required courses by expiration date report 570 is linked to the data which forms the basis of that report and that data can be accessed by selecting a data item 575 on the report 570.

For example, as illustrated in FIG. 4C, when a location data item 575 is selected on report 570, an expired course detail report 580 may be presented. Again, the example illustrated in FIGS. 4A through 4C relating to human resources and training information provide an example of a hierarchical multilevel reporting system where each level of information can be linked to the next underlying level until the ultimate native database application can be reached.

As will be appreciated, such a hierarchical multilevel reporting system can be of significant value to a manager in an organization. For example, in a manufacturing organization, a manufacturing engineer might find the reporting capabilities and levels illustrated in FIG. 3A through 3E extremely valuable. Similarly, a human resources professional might find a reporting capability such as illustrated in FIG. 4A through 4C extremely valuable.

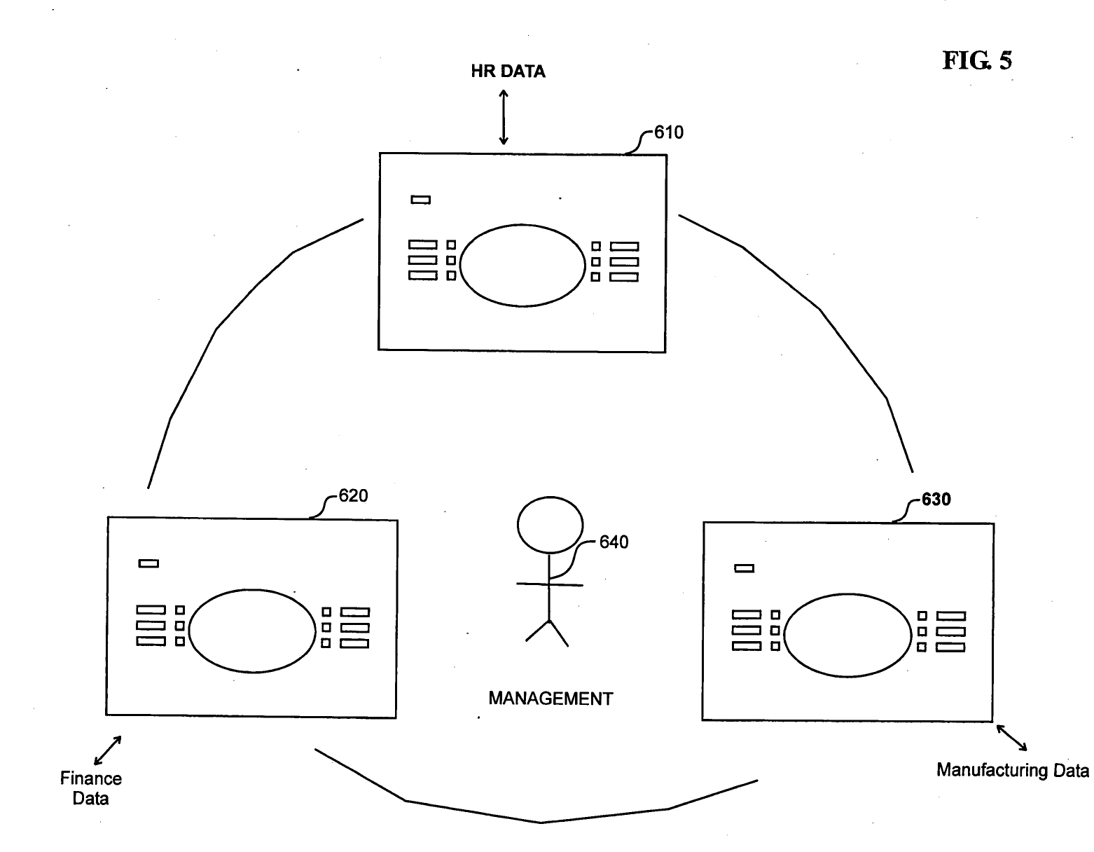

An important aspect of the present invention includes a series of dashes, where each dash, with its underlying data reporting hierarchy, is adapted for a particular functional purpose. As schematically illustrated in FIG. 5, a business manager may need access to diverse functional areas of data, including human resources data, finance data and manufacturing data. Each organization can quickly obtain appropriate data through a customized dash for their organization. For example, as illustrated in FIG. 5, dash 610 with its underlying data hierarchy (not shown) may provide human resources data. Similarly, dash 620 with its underlying data reporting system may provide financial data, while dash 630 with its underlying supporting data may provide manufacturing data.

Also as illustrated in FIG. 5, a manager who has access to human resources data dash 610, financial data dash 620 and manufacturing data dash 630 can consult each respective one of these dashes 610, 620, 630 to obtain information relevant to that area. Because the dash information is presented first at a summary level and later through links to a detailed level, a manager 640 can navigate through links on the dash down to the level of information most useful to that manager. Thus, by having (1) information readily available from many data sources and (2) information summarized in a useful and comprehensible manner, the manager 640 is empowered to exercise improved judgment.

Further, by utilizing resources from throughout a company, the knowledge, skills, and experiences of the company can be leveraged and used to develop applications that are useful, efficient and robust.

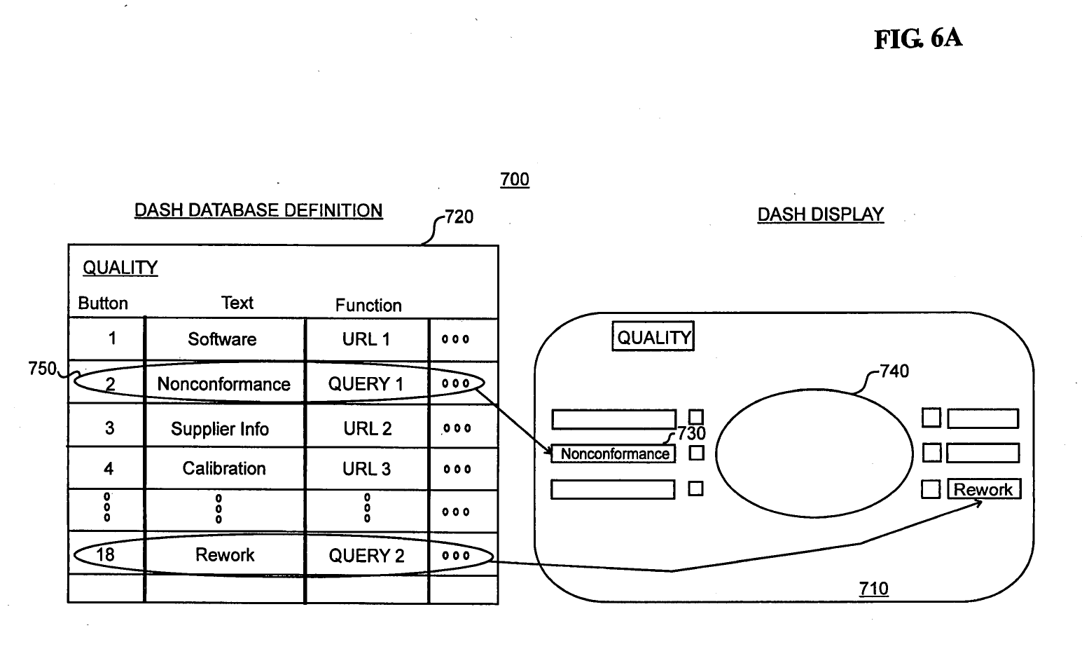

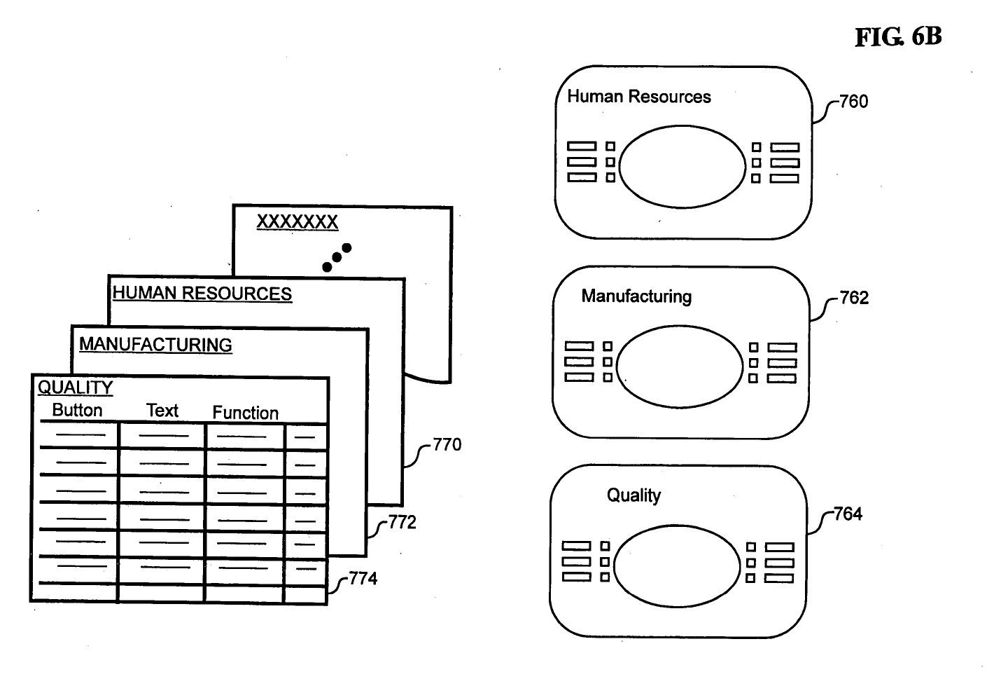

The discussion will now turn toward the infrastructure supporting the dash display. For example, as illustrated in FIG. 6A, a particular dash display 710 is shown. Dash display 710, like the dash display 200 illustrated in FIG. 2, includes a series of labels 730, and a central display region 740. Label 730, as previously discussed, includes a programmed functionality that has been associated therewith. In fact, each label 730 on dash display 710 may include an associated functionality. That functionality optionally may include a title, which is shown in the label region, and may also include a function, link, query or URL which is called when the label is selected. As shown in dash database definition 720, a preferred embodiment of the present invention includes a database which defines the functions for each label.

Dash database definition 720 illustrates a particular database suitable for a dash pertaining to quality issues. The database illustrated in dash database definition 720 comprises a series of rows or records, each one of which corresponds to a label on the dash display 710. Each record comprises a plurality of fields which define relevant attributes for the corresponding label. For example, label number two in dash display 710 would have optionally associated therewith record number two 750 in dash database definition 720. Record number two would define, for example, that label 730 should be entitled “nonconformance” according to the first field of that record. Similarly, record number two may define that query 1 should be invoked when label 730 is selected from dash display 710. This can be seen from dash database definition 720 as the second field of the second record 750. Similarly, other records in dash database definition 720 provide the definition and associated functionality for other labels on dash display 710. Again, each record 750 comprises a plurality of fields and each field defines an attribute of the associated label.

By use of dash database definition 720, a record can be conveniently maintained which defines the functionality for each label 730 of a given dash display 710. The label title or functionality of each label of dash display 710 can be modified by modifying the records and/or fields in the dash database definition 720 associated with that dash 710. Thus, as one of ordinary skill in the art will appreciate, in the situation where several dash systems are employed, each one of those dash systems would have associated therewith a database definition or a portion of a database definition. This concept is illustrated in FIG. 6B.

As shown in FIG. 6B, human resources dash 760 has associated therewith a human resources dash database definition 770. Similarly, manufacturing dash 762 has associated therewith manufacturing dash database definition 772. And finally, quality dash 764 has associated therewith quality dash database definition 774. As explained with reference to FIG. 6A, the dash database definition for each respective dash includes records for each one of the labels on the corresponding dash. Although three individual databases are depicted in FIG. 6B, one of ordinary skill in the art will appreciate that three discrete sets of data each comprising records can be concatenated into a single master database so long as the association of the records pertinent to each respective dash can be separately identified.

Since each dash has a dash database definition associated therewith, a collaborative environment can be created wherein information can be exchanged throughout the company (e.g., across organizations and groups). Such an exchange of information can be mutually beneficial to all the organizations involved.

In one embodiment, the data sources, reports and user interfaces can be designed in such a way that the same application and data can be used by other organizations (e.g., within the same company). To this end, data, data sources, application files and associated information should be accessible to both end users and developers, and should be easily modifiable to meet the specific needs of a functional area or program. In one embodiment, in order to avoid security concerns, public data (i.e, data that may be viewed by the general employee population) should be used as much as possible. Of course, sensitive data can also be included on a dash as long as appropriate security measures are taken to restrict access. Such restricted data may not be available to other end users or developers.

One additional feature of an embodiment of the invention is the capability to create a custom dash. One aspect of this feature relating to custom dash development is the use of a graphical interface that serves as a central access point to various files and applications to allow users to create and define their own custom dash interface. As explained more fully below, such a graphical interface preferably provides the option of choosing applications and files from existing dashes, or designating new applications and files directly. The color of the center display can also be customized. Once the buttons are defined, the dash can be saved as a demonstration (or prototype) version. A saved demonstration version can be edited by returning to the initial screen and accessing the saved demonstration dash a second time in edit mode. When a prototype custom dash is in final form, it can be saved as an official enterprise dash.

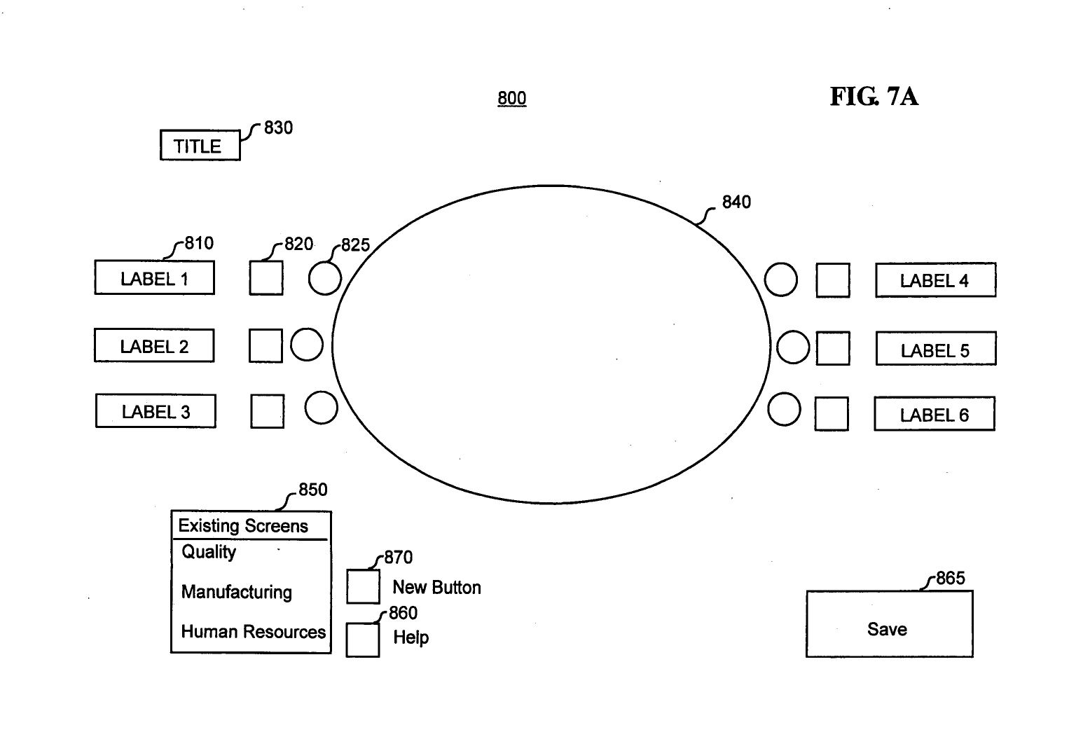

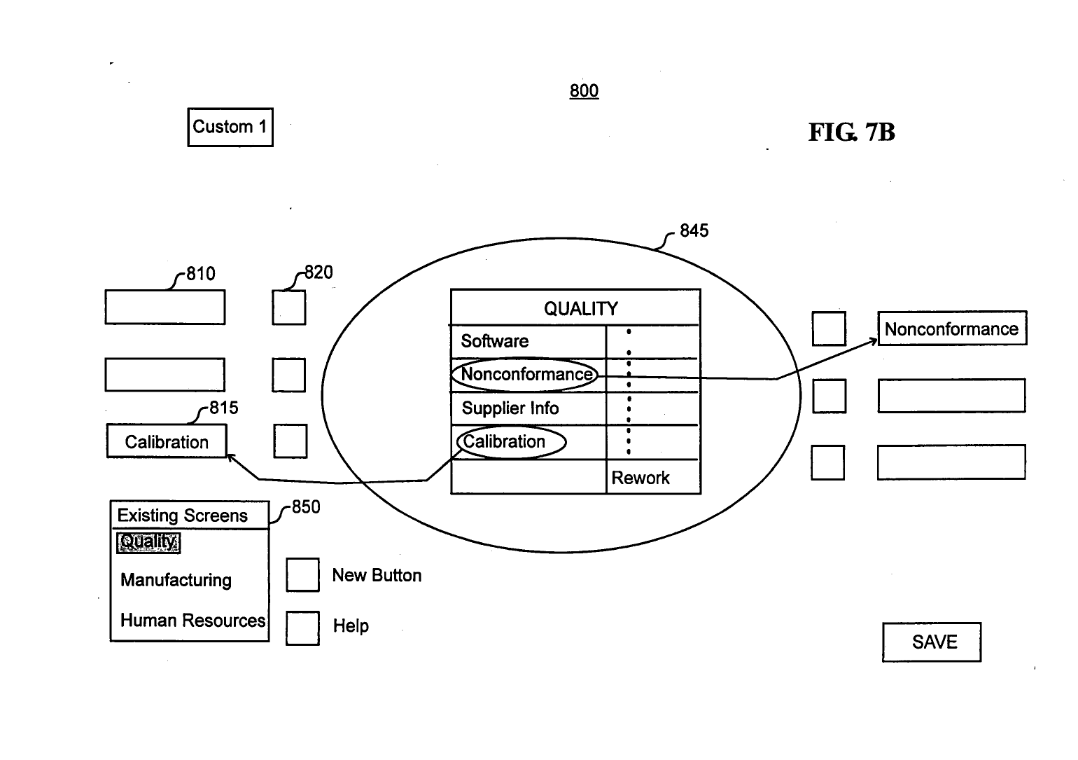

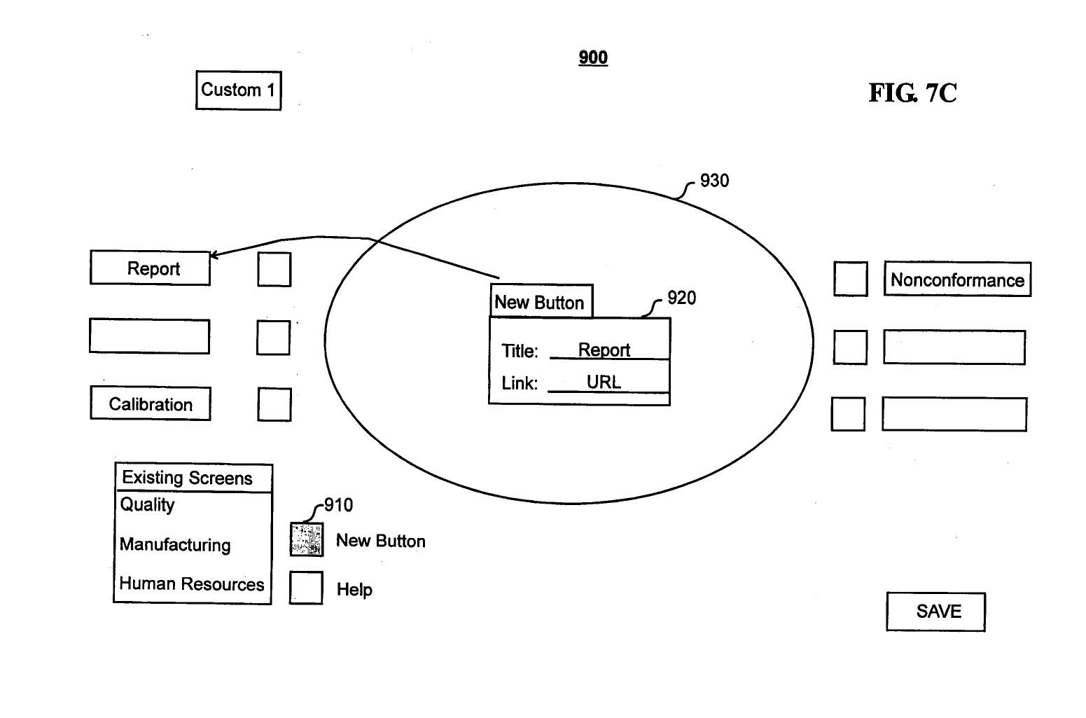

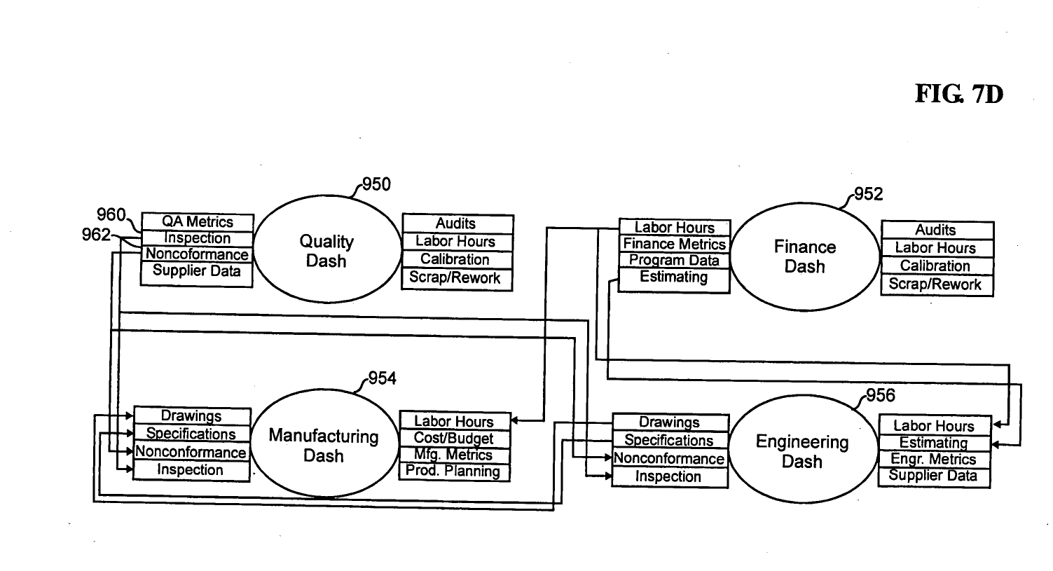

More specifically, FIG. 7A illustrates a blank dash template 800 that can be employed to create a custom dash display. Blank dash template 800 includes blank label fields 810, blank indicator fields 820, label remove buttons 825, a blank title field 830, and blank central display region 840. Blank dash template 800 also includes a selection region 850 for selecting an existing dash as an information source. Blank dash template 800 also includes additional functional selections such as a help button 860, a save button 865 and a new button 870. The label remove buttons 825 can be used to delete a corresponding label 810 from the dash template 800. The help button 860 can be used to provide instructions or other assistance. The save button 865 can be used to save the current dash. Blank dash template 800, according to preferred aspects of the present invention, can be used as a tool to build a custom dash. Specifically, a dash may be regarded as an information layout scheme and an associated underlying functional definition. Because the dash database definition provides the functional definition, a blank dash template 800, when associated with a dash definition database becomes a custom dash having the functionality defined by that dash database definition.

For example, again referring to FIG. 7A, label 810 on blank dash template 800 has no functional operation associated with it. While it is possible to manually populate a dash database definition with records and fields of information to define and describe the operation of this label, the present invention provides additional tools for this purpose. Specifically, as illustrated in FIG. 7B, the blank dash template 800 can be used to build a custom dash by building on existing previously defined dashes. Specifically, in selection region 850, a user wishing to create a custom dash may select an existing dash as an information template.

For example, a quality dash which was previously designed can be selected as an information source. When the preexisting quality dash is designated as an information source, the labels associated with that quality dash are displayed in central display region 845 as shown in FIG. 7B. Specifically, the previously defined quality dash included labels such as software, nonconformance, supplier info, calibration, and (among other things) rework. In the event that a custom dash wishes to have the same calibration definition as employed in the quality dash, the present invention permits that calibration definition to be extracted from the quality dash and imported into the custom dash under construction.

In a preferred embodiment of the present invention, a graphical drag and drop interface is provided which allows a custom dash developer to merely click on a preexisting dash label shown in central display region 845 and drag that label to a label 815 on the custom dash under development. Alternatively, a preexisting dash label can be selected by using a pull-down or another type of selector. By this process, a dash database definition for the custom dash is created where the particular record associated with label 815 is replicated based on the corresponding dash database definition record from the quality dash database definition. Similarly, if a custom dash 800 under development also wishes to have a nonconformance label like that provided on the quality dash, that label too can be copied from the quality dash and imported into the custom dash. Significantly, while the examples of preexisting dash displays described thus far have single functional focuses, such as quality or manufacturing, it will be appreciated that the creation of a custom dash can rapidly cross these functional boundaries. For example, during creation of a custom display, a quality dash may be selected as a source for creating a calibration label, but then a human resources dash may be selected to define a second label on the custom dash.

This technique of extracting previously defined functions, attributes, labels, titles and underlying capabilities from a previously defined dash and exporting them into a custom dash vastly accelerates the development speed for custom dashes within the organization. Moreover, this technique provides a heretofore previously unachieved degree of consistency across an organization in data utilization. For example, if a quality assurance department defines the proper techniques for software performance assessment, once that software performance is programmed into a label on the quality assurance dash, that functional capability is immediately available to all other makers and users for their custom dashes. As a result, all areas of an organization can employ the same best practices and best techniques for data analysis and presentation as the functional areas most expert in dealing with that data. Thus, everybody in the organization can look at the same data in the same way without the option or ability to recast the data favorably or unfavorably.

The custom dash may also include newly defined labels not previously existing on other dashes. For example, as shown in FIG. 7C, a blank dash template 900 is illustrated where a custom button is to be created. Specifically, because no preexisting dash includes the desired capability, the specific details of the custom label must now be provided. In other words, in contrast to dragging and dropping a completely predefined function from another dash, the new button utility allows a basic record definition to be defined in the dash definition database. As shown in FIG. 7C, when the new button request indicator 910 is selected, a dialog box 920 is presented in central display region 930. Dialog box 920 provides for user input fields for information such as the title of the label, a link, query, URL or other application such as Flash movie name, which is to be invoked when the label is activated, and other information necessary to populate the dash database definition record. For example, for a flash movie, the user would indicate a flash movie instead of a URL when defining a button, and input the directory path and name of the flash file.

In a preferred implementation, dialog box 920 is configured so that the dash buttons can link to any file or application as long as the web browser recognizes the URL.

Thus, by either importing previously defined buttons from other dashes or by defining individual custom buttons for the dash, or a combination of these two techniques, a new custom dash can be defined with great speed and ease. Significantly, once a new custom dash has been defined, consistent with security permissions within an organization, such new custom dash can immediately be added to the list of available dashes accessible for the creation of subsequent custom dashes.

FIG. 7D illustrates a plurality of display dashes in accordance with the present invention which share link or query button definitions. For example, quality dash 950 is configured to display data pertinent to, for example, a quality assurance employee, finance dash 952 is configured to display data pertinent to a financial employee, manufacturing dash 954 is configured to display data pertinent to a manufacturing manager, and engineering dash 956 is configured to display data pertinent to an engineering manager. Quality dash 950 may include, for example, an inspection button (i.e., label) 960 for displaying inspection data and a nonconformance button 962 for displaying nonconformance data. Further, manufacturing dash 954 may also include inspection button 960 and nonconformance button 962. Since the nonconformance button 962 is the same for both the quality dash 950 and the manufacturing dash 954, both the quality assurance employee and the manufacturing manager can view the same nonconformance data and view the data presented in the same way. Thus, although monitoring nonconformance information may be primarily performed by the quality assurance employee, the same criteria for viewing nonconformance information can also be employed by the manufacturing manager.

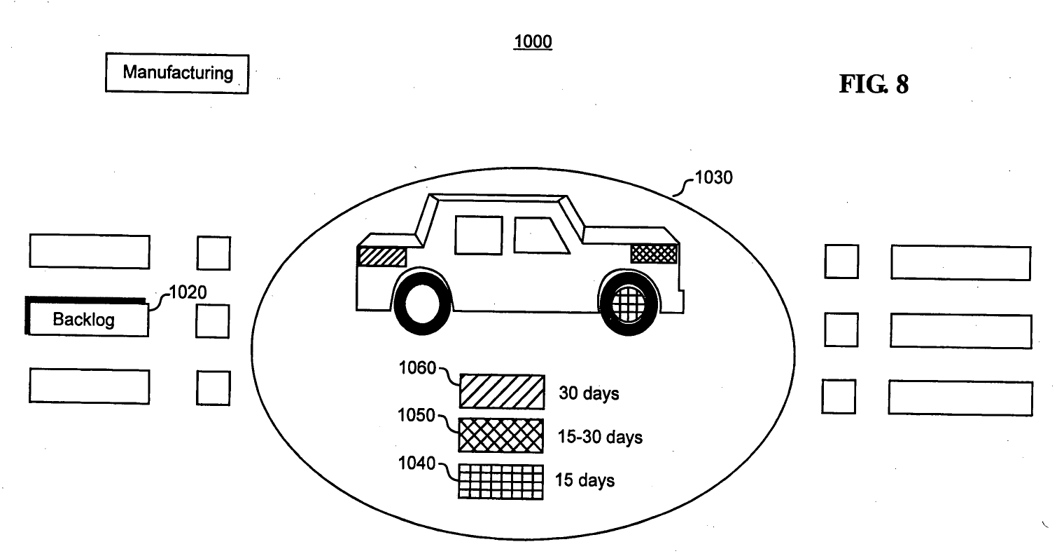

FIG. 8 illustrates an embodiment of a dash 000 which has been configured to provide three-dimensional image data. As shown in FIG. 8, title field 1010 shows a particular title for dash 1000 (i.e., manufacturing). Label 1020 indicates a particular subject area, backlog, for the label. Because dash 1000 is for presenting manufacturing information for, in this case, an automobile, label 1020 can be used to track the backlog associated with various components of the automobile.

Dash 1000 further includes a central display 1030 showing a graphical illustration of the automobile that is the subject of the dash. In one embodiment (not shown), an image of the automobile is presented. Activation of the backlog label 1020 invokes a number of backlog indicators. Specifically, backlog indicator 1040 indicates components having a backlog of 15 days or less (e.g., wheels). Backlog indicator 1050 indicates components having a backlog between 15 and 30 days (e.g., front fender). Backlog indicator 1060 indicates components having a backlog greater than 30 days (e.g., rear fender). Thus, a user can view an image of the automobile on the central display 1030 and quickly determine the types of components that are backlogged and the amount of delay in receiving the backlogged components.

In one embodiment, the image shown on the central display 1030 can be a three-dimensional image. A user can be given the option to rotate and view the image from a plurality of perspectives. By selecting one of the various components from the image, a more detailed image of the selected component can be displayed. Alternatively, selection of a component could lead to a textual, alphanumeric, or graphical information display for providing details about the component, such as cost, manufacturing yield, or delivery data.

In one embodiment, a two or three-dimensional image can be generated, for example, in real-time from stored data, such as computer aided drafting (CAD) data. In another embodiment, a two or three-dimensional image can be stored in the data source 110 and retrieved for display on a dash. The image can then be inspected visually to give the user a better understanding of the relationship between product components. For example, if a part is out of tolerance, a three-dimensional depiction of the physical relationship of the out of tolerance areas can be used to assist a user in understanding the scope of the problem. Thus, not only can a three dimensional object such as a 3D graph be displayed in the central display 1030, but also a graphical representation of an object, a flow diagram, a manufacturing line, etc., can be shown. Moreover when an object, a flow diagram, a manufacturing line, etc. is shown, the image itself can be either annotated with data from the data source 110 or a visual or graphic attribute of the image (e.g., color, bold, blink, highlight, etc.) or a part of the image can be varied to provide a visual indication of the status between the data and the object or diagram shown.

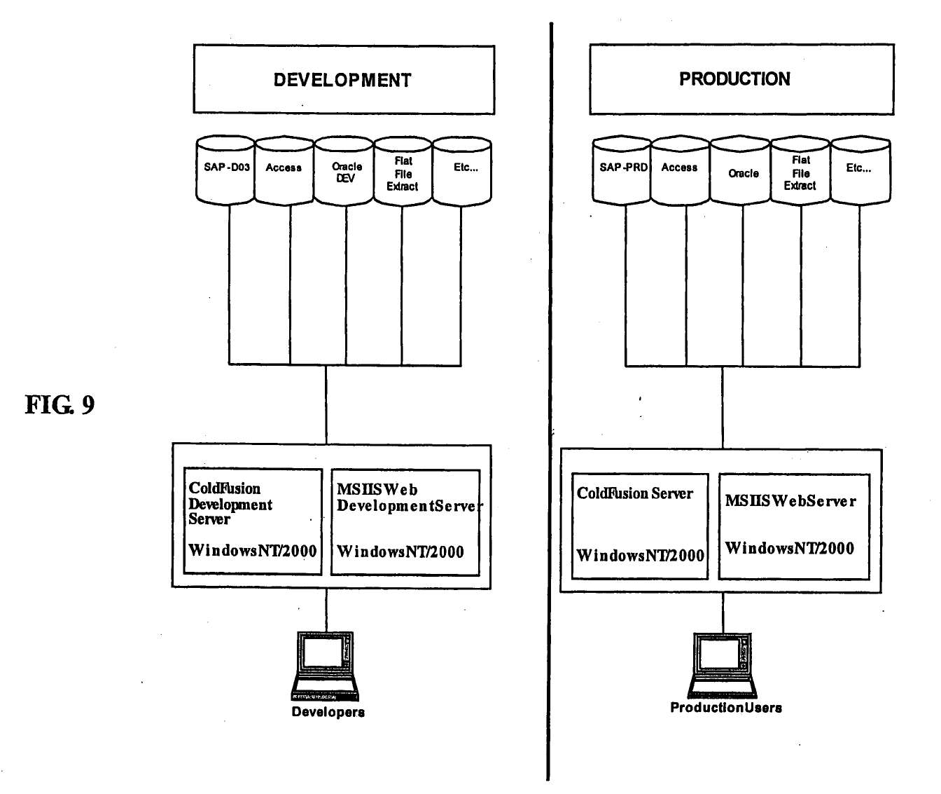

FIG. 9 illustrates an embodiment of a computer network environment suitable for creating and using a dash in accordance with the present invention. In one embodiment, development of dash applications can be performed via a Windows NT/2000 server running ColdFusion Development Server and Microsoft Internet Integration Server (IIS) Web Development Server. The ColdFusion Development Server can be used to provide access to various data sources, including: SAP, Access, Oracle, flat file extract and/or other database platforms, while the Microsoft IIS product can be used to develop and deploy web-based applications. Developers can use, for example, personal computers having the following desktop products: Internet Explorer, Macromedia ColdFusion 5.0 or MX, and Macromedia Flash 5.0 or MX.

End users can, for example, access the dash applications using personal computers having the following desktop products: Internet Explorer, network (LAN) access, Macromedia Flash Player, and Java Runtime Environment. The end user computers can access the dash applications via Internet Explorer, which is adapted to operate with Microsoft IIS Web Server. The ColdFusion Server provides the user computers with access to the various data sources, including: SAP, Access, Oracle, flat file extract and/or other database platforms. Of course, the end users can also use the development environment to access the dash applications.

The dash display system according to the foregoing described embodiments can also be used as a tool in a unique collaboration methodology. Specifically, for example, vendors and customers may share common sets of information and access that shared information via dash interface systems according to the described embodiments. By providing cross-platform access to data, and by providing data in a form and format which is defined by the process owner responsible for that data, vendors and customers alike may achieve a common view on data and the status of matters which the data represents.

For example, a government agency and a government contractor may set up a common set of information relating to execution of a government contract. Various dash displays may be defined relating to cost, schedule, component testing, quality assurance, data items, etc., which draw information from the native sources where this information is historically maintained. However, by collaborative use of the dash system according to the present invention, both the contractor (as well as possible subcontractors) and the government agency can achieve, for example, near real time access to program information, schedule, cost and status of deliverables. More importantly, both the contractor and the government agency would receive similar views of the information from common data sources. Thus, alerts, indicators of status and real time measurements would be (preferably or optionally) equally available to both parties.

A still further embodiment of the present invention includes user authentication and access control capabilities. For example, an organization may wish to control which users have access to certain information and/or whether certain users have read only versus update permission relating to specific types of information. In a preferred implementation of the present invention, a user's network logon information could be accessed by the dash display system thereby eliminating the need for a separate logon to the dash display system. Once user authentication and identification has been accomplished user permissions for access, update, etc., can be performed.

More specifically, in an embodiment of the present invention, a user access control table would be maintained which contains information sufficient to enumerate each relevant permission or prohibition for each user. Such user access control table could be created for a system wide implementation and would be accessed for permission information for all dash displays. Alternatively, a dash display specific user access control table could be created. In the custom dash creation system, such user access control information can also be used to control which preexisting dash labels 815 could be selected by a user to add to that user's custom dash under development. As will be understood, such user access control table can not only list each user but can also be implemented on a group or role basis where each user is identified as a member of a certain security “group” and permissions or prohibitions are established at a group level. For example, all employees in the HR department may be granted certain permissions to access HR data while employees in an engineering department may not have permission to access HR data.

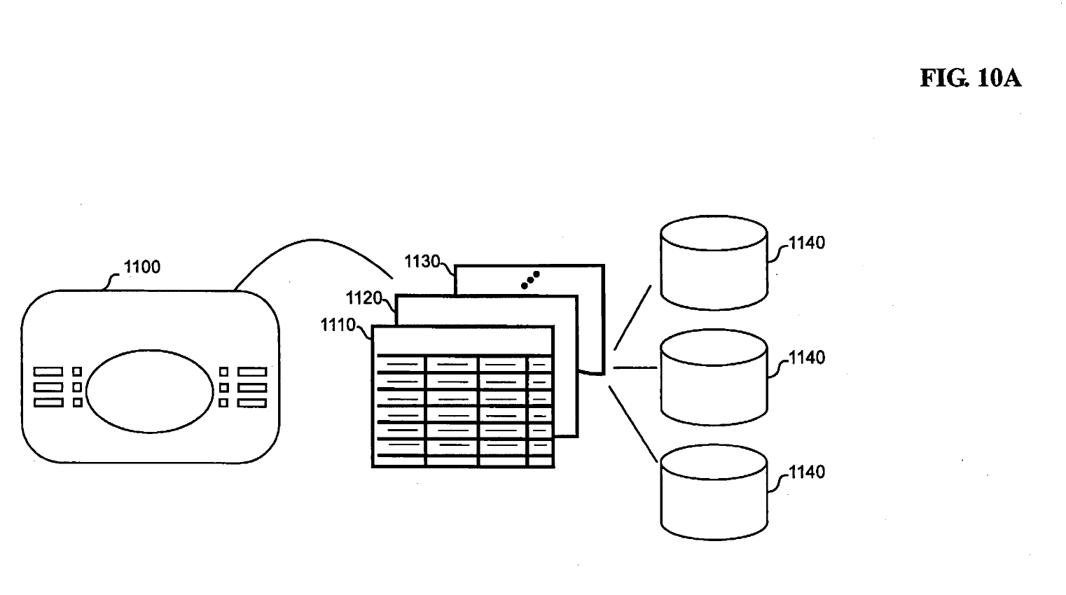

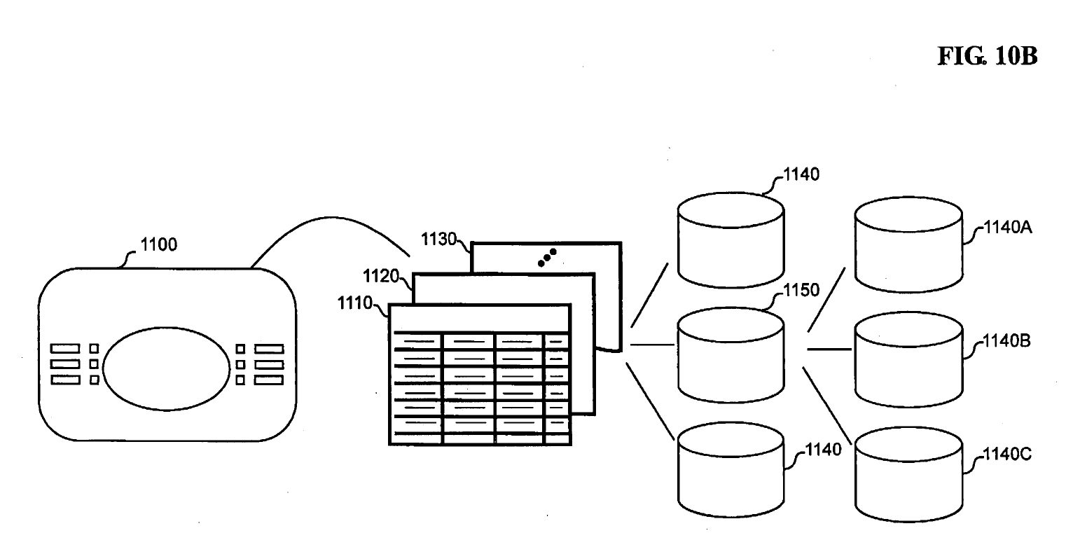

A still further embodiment of the present invention includes multiple tiers of linked databases. For example, as illustrated in FIG. 10A, the foregoing examples and embodiments of the present invention can be thought of as a dash 1100 which provides links to a series of information screens 1110, 1120, 1130 which are supplied with data from databases (generally designated 1140). In the foregoing examples, although various databases 1140 are accessed, each of these databases 1140 are accessed directly. Also as discussed with regard to the foregoing embodiments, the various databases or data sources 1140 may be any manner of data sources such as SAP databases, Oracle databases, flat file databases, SQL databases, XML databases, Btrieve databases, Access databases, FoxPro databases, Excel files, etc. Moreover, the data sources may also include streaming data sources provided, for example, by a sensor or process control system.

As an alternative to the structure illustrated in FIG. 10A, an embodiment of the present invention can also be implemented in a tiered database structure such as conceptually illustrated in FIG. 10B. FIG. 10B generally illustrates a dash 1100 which provides links to a series of information screens 1110, 1120, 1130 which are supplied with data from direct databases 1140 as well as an intermediate database 1150 (which may alternatively be referred to as a “datasource”). Significantly, intermediate database 1150 is, in turn, linked to additional direct databases 1140A, 1140B, and 1140C. In this structure, information from direct databases 1140A, 1140B, and 1140C can be extracted and imported into intermediate database 1150. Alternatively, information from direct databases 1140A, 1140B, and 1140C can be linked or streamed into intermediate database 1150

Numerous advantageous benefits can be achieved with the structure such as shown in FIG. 10B. First, by using an intermediate database 1150, user access commands which originate from user interactions with dash 1100, are directed to intermediate database 1150 instead of being directed to native databases 1140A, 1140B and 1140C. As a result, native applications running directly on databases 1140A, 1140B and 1140C do not compete for network or database access bandwidth with the users seeking to obtain data for dash reporting purposes. Second, by using intermediate database 1150, additional security and access authorization protocols may be implemented. For example, if databases 1140A, 1140B and 1140C relate to native applications for, for example, payroll, purchasing, and accounts payable, these native applications are likely to have very tightly controlled security access permissions. The tight security access permissions are required to prevent unauthorized access or, perhaps more importantly, unauthorized alteration of the data in these critical databases. Thus, in regard to security and access protocols for the native applications whose data is stored in databases 1140A, 1140B and 1140C, it would be typical to limit the number and types of persons who are provided access.

However, because the dash reporting system according to the present invention provides a possibility of reporting data widely throughout the organization, the dash reporting system also may provide information to a scope of users beyond the normal circle who directly employ the native applications. In other words, persons beyond an inner circle of native application users may now interact with the native application database information. Rather than burden the native application access permission and authorization capabilities with numerous new users, information in the native databases 1140A, 1140B and 1140C can be extracted or exported to an intermediate database 1150.

With this approach, access permission and authorization capabilities of the dash reporting system would be employed to control access to the native residing in the intermediate database 1150, rather than the systems relating to the native applications. In other words, administration of the native applications for user access permissions is simplified by use of an intermediate database. Specifically, once information is extracted or exported to intermediate database 1150, it is possible to provide a completely independent method for establishing user access permissions to intermediate database 1150 from the user access permissions provided by way of the native applications. Thus, the dash reporting system of the current invention can more unobtrusively interact with data and native applications without requiring modification to either the native applications or the user access permission protocols or by imposing on the personnel who administer these native applications.

Also, because the data in intermediate database 1150 can desirably be a duplicate copy or backup copy of the data from the native databases 1140A, 1140B and 1140C, an organization would have reduced concern about inadvertent modification of the data either resulting from purposeful manipulation or inadvertent change.

A still further benefit of the intermediate database 1150 is the ability to use the intermediate database 1150 as a universal data format translation mechanism. Specifically, the dash reporting system of the present invention must have access to every type of database from which information is to be reported. As will be apparent to persons of skill in the art, some types of databases may be more easily linked to, and other types of databases may be more difficult to link to. Additionally, certain databases may have difficult to modify interface characteristics, making connection to the dash reporting system difficult or expensive. Moreover regardless of whether a database is “easy” to link to or “hard” to link to, an organization may possess more internal knowledge and familiarity with certain types of databases and less familiarity with other types of databases. Accordingly, for any or all of the foregoing reasons, an organization may have a preference for certain database formats over others and the intermediate database can thus be used to facilitate access to information from native databases of all types.

More specifically, for example, information from native database 1140A may be exported to intermediate database 1150 and in the process of exporting the format of the data may be simplified or altered so that when the information is put into intermediate database 1150, said information can be more easily accessed. For example, if database 1140A is an SAP database, it is possible that intermediate database 1150 might be an MS Access database. Because techniques and API tools for accessing information from MS Access databases are widely known, an organization may be more comfortable or more capable of accessing the information in intermediate database 1150 because it is in a familiar format, MS Access. In contrast, SAP, while an extremely high performance system, may be a complex system to interoperate with. Accordingly, integration of the dash system with a sophisticated program such as SAP might require more sophisticated skills. Ultimately, by use of an intermediate database 1150, every type of data source or database can be accessed by the dash reporting system of the present invention so long as the information can be extracted, exported or linked to in the native database and pulled into the intermediate database 1150 and by constructing the intermediate database 1150 in a format which can be linked into the dash reporting system. Thus, as a result of using an intermediate database 1150 the dash reporting system of the present invention can be implemented and its benefits enjoyed without forcing an organization to implement a custom database access API for every type of database employed by the organization.

In the description above, it was explained that the intermediate database 1150 can be employed as a universal translator so long as information from native application databases 1140A, 1140B and 1140C can be extracted. Many different techniques can be used to extract information from native application databases 1140A, 1140B and 1140C. For example, to provide a simple illustration first, it may be possible to “print to a file,” to obtain information from native application database 1140A. Such “print to a file” technique may result in a text-type file of the data printed from database 1140A. Next, by way of either by automatic or manual means, the file printed from database 1140A can be imported into intermediate database 1150. As a result of this technique, intermediate database 1150 is unaware of the type of database from which the data was obtained. In theory, even if a native application database existed to which the dash reporting system could not be directly linked, such information could nevertheless be accessed by way of employing intermediate database 1150 by a technique such as described above.

Similarly, information in native application databases 1140A, 1140B and 1140C may be regularly output by way of standardized or custom “reports.” Such reports, so long as they are in electronic format, can then be linked or imported into intermediate database 1150. From such a report, not shown in the figures, information could be collected into fields and from that the report, information can be put into a web type graphical user interface environment. Similarly, information in native application databases 1140A, 1140B and 1140C may be output by way of “save as” or “export as” functions which are provided by the native application. Finally, depending on the type of native application database, certain native application databases 1140C may allow data to be “streamed” from database 1140C directly to intermediate database 1150 either in real time or non real time.

As persons of skill in this art will understand, information from native application databases 1140A, 1140B and 1140C can be regularly or continually updated from native application database to the intermediate database 1150. The frequency of which information from the native application databases should be updated to the intermediate database 1150 will depend on numerous factors. For example, if the information in native application database 1140A typically changes on an hourly basis, then information in intermediate database 1150 must be updated frequently to keep that information current. If, in contrast, information in native application database 1140C is updated only monthly, then the corresponding portion of information in intermediate database 1150 can be updated on a similar schedule.

As persons of skill in the art will also understand, various scheduling techniques and utilities can be employed to automate routine updates from native application databases 1140A, 1140B and 1140C so that data is exported on a timely and recurring basis. In this way, either automatic, semiautomatic or manual processes can be used to routinely export data and then import the data into intermediate database 1150 to keep the intermediate database 1150 information up to date. Finally, as discussed above, the reports and data exports from the native application databases 1140 can be automatic, semiautomatic or manual. Such output can include an SAP timed output, an Oracle timed output, an Oracle timed query, as well as a real time query passed directly from the dash system.

Yet another advantage of an intermediate database 1150 is that its use can facilitate rapid development of dash applications. For example, as previously discussed in the present specification, an advantageous use of the dash system is to quickly develop and implement a custom dash for an individual user. When users can quickly see the power, value and potential of their dash, the user will participate more easily in the customization of their dash. Moreover, as previously noted, such interaction increases the user's satisfaction and sense of ownership of the custom dash. However, in the situation where a particular user wishes to obtain data from a native application database 1140C, which is a complex database such as SAP, detailed computer configurations may be required. In this situation, it is undesirable to slow the implementation of a custom dash solely for the purpose of providing the links necessary to obtain live access to a complex database. As a result, intermediate database 1150 provides a mechanism to rapidly prototype a custom user dash that provides access that that user's data and which temporarily or permanently avoids the need to develop a native application database access link, API or tool.

In this approach, information either required by a user or representative of a user can be exported or printed from native application database 1140C. This exported data is then imported into intermediate database 1150 which is in a database format which can easily be quickly and easily accessed by the dash system. Then, having deposited representative user data in the easily accessible intermediate database 1150, the programmer can then concentrate on developing the user's custom dash interface and can easily link that prototype dash to a copy of the uers's data. Thus, the programmer can concentrate on developing the user's custom dash interface without the delay or distraction required to connect the back end of the dash system to a native application database 1140.

A further aspect to the system when an intermediate database 1150 is employed is described next. An important aspect to the present invention is the ability of a dash to provide information links to more detailed tiers of information. This general concept is described in relation, for example, to FIGS. 3A-3E. As will be recalled, a user can select a button 320 on FIG. 3A and selecting that button 320 will invoke a display 345 as shown in FIG. 3B. Further, selecting an item in display 345 in turn can link a user to a detailed report such as that shown in FIG. 3C.

This concept of linking to levels of information may also be employed in an architecture employing a intermediate database. In this system, a user interacting with dash display 1100 as shown in FIG. 10B can selectively, iteratively or consecutively link to displays 1110, 1120 and 1130. Then, from a detailed or intermediate level report 1130, the user may link directly to a native application reporting system such as, for example, a native application providing data in database 1140. Alternatively and additionally, a user may link from an intermediate report 1130 to intermediate database 1150 which provides an aggregation of data in web graphical user interface format compiled from a plurality of native application databases 1140A, 1140B and 1140C. This information display of data from intermediate database 1150 in turn can link directly to native application reporting utilities for data stored in databases 1140A or 1140B or 1140C.

Accordingly, as is apparent, numerous and significant benefits including security, the minimization of direct hits interfering with native applications, firewall-like security as well as archive benefits, which are only a representative set of examples, can be achieved by interposing an intermediate database in the system. As will be appreciated, the dash system according to the present embodiments may interact with certain databases directly such as database 1140 in FIG. 10B while also simultaneously interfacing with intermediate databases 1150. In other words, all databases which are accessed by the dash reporting system do not need to be the same type of database nor do they need to be at a same “level”.

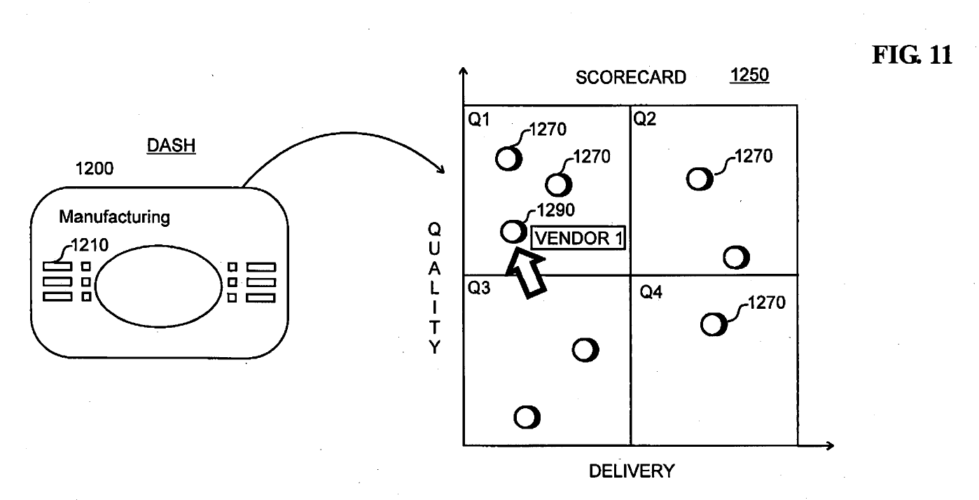

Yet another aspect and feature of the present invention will be described next with regard to FIG. 11. As described previously, the dash reporting system can display many different types and purposes of information. One particular example of a display includes what the present inventors have termed a “scorecard”. As shown in FIG. 11, dash 1200 may include a button 1210 which, when selected, invokes a display 1250 which is a vendor scorecard. As an example, the scorecard may include a top level conceptual graphic representation of information. As illustrated in FIG. 11, for example, scorecard 1250 provides a quality-delivery coordinate system for portraying vendor performance. Each point 1270 on the scorecard represents a particular vendor and the position of the point is indicative of that vendor's performance. A vendor in the top half of the display has high quality, while a vendor in the bottom half has lesser quality. Similarly, a vendor in the right half has a high delivery score, while vendors in the left half have a low delivery score. Typically, a vendor wishes to have both high quality and a favorable delivery score. The combination of high quality and high delivery score corresponds to the upper right hand region of the scorecard labeled Q2. Vendors in region Q2 have both high quality because they are in the top half and high delivery score.

In a preferred implementation of the present invention, the vendor scorecard 1250 is configured so that a user may interact with the scorecard with a pointing device such as cursor or mouse. For example, if the cursor is directed to a vendor 1290, in the region of the scorecard Q1, preferably, as the cursor approaches or passes over vendor 1290, the name of the vendor pops up in a text box. As shown in scorecard 1250, the name may pop up “vendor 1.” Significantly, the link down reporting capability described previously is also employed on the scorecard. Specifically, when a user directs the cursor or mouse to a particular vendor, the user can then click on the point 1270 representative of the vendor to link to a next level report which provides more information about that vendor. Thus, just as described with regard to FIGS. 3A-3E and FIGS. 4A-4C, a user interacting with scorecard 1250 may link through multiple levels of reports, not shown, to ultimately connect to a native application that is used to record and report quality or delivery information.

Significantly, the scorecard can represent a compilation of data from multiple databases, multiple locations or multiple programs (projects). In other words, a vendor may serve a company in more than one geographic location, for instance, yet the organization may have no effective way of monitoring overall vendor quality performance across all locations. According to the capabilities of the present dash system, however, vendor information from multiple databases can be aggregated either directly or by means of an intermediate database, and the information provided at the top level scorecard thereby represent aggregated or total performance information.

Similarly, quality information about a vendor and delivery information about a vendor may historically be maintained separately. Use of the scorecard 1250 and dash reporting system of the present invention allows these two important vendor performance metrics to be compared and cooperatively evaluated. Again, the dash reporting system can obtain the information from multiple databases and aggregate this information either directly or by way of an intermediate database. By this process, for example, aggregated information from multiple geographic locations can be merged, or performance across multiple programs (projects) can be summed.

In a preferred implementation, the point associated with each vendor 1270 within the quadrants of the scorecard can be illustrated by a icon or other indicator and thereby be further categorized by different levels. For example, although there are three vendors in quadrant one Q1, each vendor may be further distinguished by a grade (e.g., A, B, C, etc.) or number (e.g., 1, 2, 3, etc.) or attribute (e.g., platinum, gold, silver, or bronze) or icon type (e.g., square, circle, diamond) designation. Such designations levels can be selected based on differences between vendors as measured within a quadrant or as measured across quadrants. Similarly, each quadrant can be color coded or otherwise distinguished by visual or graphic characteristic.

Additional benefits of the scorecard type reporting system include the benefit of being able to use such assimilated information for purposes other than vendor quality-delivery evaluation. For example, such a dash type report output can be given to a vendor for quality-delivery remediation.

Moreover, the scorecard can report other metrics besides quality and delivery. The scorecard can for instance be used to report internal organization operations such as organizational operations across multiple organization business units. Such tool which can aggregate information from diverse sources, correlate and compare that information, and then display a map of aggregated information can be useful in countless situations. For example, in the situation of a company merger, information from each merged component can be separately accessed by the dash system and then the information merged, compared or contrasted and presented in a scorecard type display format. In this manner, the scorecard can provide both relative comparisons between the company components as well as, perhaps more importantly, serve as a reporting bridge between what may be otherwise incompatible corporate information technology infrastructures. Similarly, by providing selective data access links to various organizations such a comparative scorecard can be used on an intra-company basis for comparative or competitive benchmarking. Still further, by way of illustrating the boundless possibilities for a scorecard report, sales, engineering and other organizations can present system-wide, organization-wide or other integrated information in a scorecard type report.

Although the present invention has been fully described by way of examples with reference to the accompanying drawings, it is to be noted that various changes and modifications will be apparent to those skilled in the art. Therefore, such changes and modifications should be construed as being within the scope of the invention.

What is claimed is:

1. A computer-based system for presenting an information display screen, comprising:
means for accessing a plurality of information sources;
means for generating a display screen template, said display screen template including at least one control, each said at least one control having at least one function associated therewith, said display screen template including at least one status indicator;
means for storing a display screen function database associated with said display screen template, said display screen function database containing at least one record of a function associated with a control on said display screen template, said display screen function database containing at least one record of a status indicator threshold;
means for selectively activating said status indicator based on information located in at least one of said information sources and on at least one status indicator threshold; and
means responsive to a control on said display screen template, for invoking a function associated with said control on said display screen template upon activation of said control.

2. A computer-based system for presenting an information display screen in accordance with claim 1, further comprising means for user authentication for controlling access to predetermined information sources based on user identification information.

3. A computer-based system for presenting an information display screen in accordance with claim 1, wherein said display screen template includes a display region for presenting selected information to a user upon activation of said control.

4. A computer-based system for presenting an information display screen in accordance with claim 3, further comprising means, responsive to activation of said control, for generating a three-dimensional image based on data stored in at least one of said plurality of information sources and presenting said three-dimensional image in said display region.

5. A computer-based system for presenting an information display screen in accordance with claim 4, wherein said mean for generating a three-dimensional image is capable of generating a three-dimensional image of an object having visual attributes thereof show a relationship between data stored in at least one of said plurality of information sources and at least a portion of said object.

6. A computer-based system for presenting an information display screen in accordance with claim 3, further comprising means for retrieving a three-dimensional image from one of said plurality of information sources and presenting said three-dimensional image in said display region.

7. A computer-based system for presenting an information display screen in accordance with claim 1, wherein said function is an operation selected from the group consisting of a hyperlink, a script, a program, and a query.

8. A computer-based system for presenting an information display screen in accordance with claim 1, wherein said at least one record of a function associated with a control on said display screen template contains a plurality of status indicator thresholds associated with a single status indicator, and
wherein said means for selectively activating said status indicator differentially activates said status indicator depending on a relationship between said information located in at least one of said information sources and a corresponding one of said plurality of status indicator thresholds.

9. A computer-based system for presenting an information display screen in accordance with claim 1, wherein said status indicator is capable of displaying more than two status indications.

10. A computer-based system for presenting a selected one of a plurality display screens comprising:
means for accessing a plurality of information sources;
means for generating a plurality of display screen templates, each display screen template including at least one control, each control having at least one function associated therewith, each display screen template including at least one status indicator;
means for storing a plurality of display screen function databases, each display screen function database being associated with a respective one of said plurality of display screens, each display screen function database containing at least one record of a function associated with a control on said respective one of said plurality of display screens, each display screen function database containing at least one record of a status indicator threshold associated with a status indicator control on said respective one of said plurality of display screens;
means for selecting one of said plurality of display screen templates for display;
means for selectively activating a status indicator on said selected one of said plurality of display screen templates based on information located in at least one of said information sources and on at least one status indicator threshold; and
means responsive to a control on said selected one of said plurality of display screen templates, for invoking a function associated with said control upon activation of said control.

11. A computer-based system for presenting a selected one of a plurality of display screens in accordance with claim 10, further comprising means for user authentication for controlling access to predetermined information sources based on user identification information.

12. A computer-based system for presenting a selected one of a plurality of display screens in accordance with claim 10, wherein each said display screen template includes a display region for presenting selected information to a user upon activation of said control.

13. A computer-based system for presenting a selected one of a plurality of display screens in accordance with claim 12, further comprising means, responsive to activation of said control, for generating a three-dimensional image based on data stored in at least one of said plurality of information sources and presenting said three-dimensional image in said display region.

14. A computer-based system for presenting a selected one of a plurality of display screens in accordance with claim 13, wherein said mean for generating a three-dimensional image is capable of generating a three-dimensional image of an object having visual attributes thereof show a relationship between data stored in at least one of said plurality of information sources and at least a portion of said object.

15. A computer-based system for presenting a selected one of a plurality of display screens in accordance with claim 12, further comprising means for retrieving a three-dimensional image from one of said plurality of information sources and presenting said three-dimensional image in said display region.

16. A computer-based system for presenting a selected one of a plurality of display screens in accordance with claim 10, wherein said function is an operation selected from the group consisting of a hyperlink, a script, a program, and a query.

17. A computer-based system for presenting a selected one of a plurality of display screens in accordance with claim 10, wherein said at least one record of a function associated with a control on said respective one of said plurality of display screen templates contains a plurality of status indicator thresholds associated with a single status indicator, and
wherein said means for selectively activating a status indicator on said selected one of said plurality of display screen templates differentially activates said status indicator depending on a relationship between said information located in at least one of said information sources and a corresponding one of said plurality of status indicator thresholds.

18. A computer-based system for presenting a selected one of a plurality of display screens in accordance with claim 10, wherein said status indicator is capable of displaying more than two status indications.

19. A computer-based system for presenting a selected one of a plurality of display screens in accordance with claim 10, further comprising means for linking an intermediate datasource to at least one additional information source, and wherein at least one of said plurality of information sources is an intermediate datasource.

20. A computer-based system for presenting a selected one of a plurality of display screens in accordance with claim 19, further comprising means, responsive to activation of said control, for displaying information based on information obtained from at least one of said plurality of information sources, in said display region.

21. A computer-based system for presenting a selected one of a plurality of display screens in accordance with claim 19, further comprising means, responsive to activation of said control, for displaying information based on information obtained from said intermediate datasource, in said display region.

22. A computer-based system for presenting a selected one of a plurality of display screens in accordance with claim 21, wherein said means for linking said intermediate datasource to at least one additional information source obtains information from said at least one additional information and stores said thus obtained information in said intermediate datasource.

23. A computer-based system for presenting a selected one of a plurality of display screens in accordance with claim 21, wherein said means for linking said intermediate datasource to at least one additional information source periodically obtains information from said at least one additional information and stores said thus periodically obtained information in said intermediate datasource.

24. A method of business collaboration using a computer-based system for presenting information display screens, the method comprising the steps of:
providing a computer-based system that can be accessed by a plurality of users;
interfacing said computer-based system with a plurality of information sources so that at least a portion of said plurality of information sources are commonly accessible by at least a portion of said plurality of users;
presenting to a plurality of users an information display screen including at least one status indicator and at least one control, each said at least one control having at least one function associated therewith;
reading a display screen function database associated with said display screen template, said display screen function database containing at least one record of a function associated with a control on said display screen template, said display screen function database containing at least one record of a status indicator threshold;
selectively activating said status indicator based on information located in at least one of said information sources and on at least one status indicator threshold; and
responding to a control on said display screen template, for invoking a function associated with said control on said display screen template upon activation of said control.

25. A computer-based system for presenting an information display screen, comprising:
a computer;
an interface device adapted to connect said computer to a plurality of information sources including an intermediate datasource;
a data link for providing a link between an information source and an intermediate datasource so that information in an information source can be provided to said intermediate datasource;
a computer readable medium containing computer executable code for generating a display screen template on said computer, said display screen template including at least one control, each said at least one control having at least one function associated therewith, said display screen template including at least one status indicator;
a computer storage device for storing a display screen function database associated with said display screen template, said display screen function database containing at least one record of a function associated with a control on said display screen template, said display screen function database containing at least one record of a status indicator threshold; and
wherein said computer readable media containing computer executable code additionally includes computer executable code for:
selectively activating said status indicator based on information located in at least one of said information sources and on at least one status indicator threshold, and
responding to activation of a control on said display screen template, for invoking a function associated with said control on said display screen template upon activation of said control.

26. A computer-based system for presenting an information display screen in accordance with claim 25, wherein said computer readable media containing computer executable code additionally includes computer executable code for responding to activation of said control by generating a three-dimensional image based on data stored in at least one of said plurality of information sources and presenting said three-dimensional image in said display region.

27. A computer-based system for presenting an information display screen in accordance with claim 26, wherein said at least one record of a function associated with a control on said display screen template contains a plurality of status indicator thresholds associated with a single status indicator, and
wherein said computer readable media containing computer executable code additionally includes computer executable code for selectively activating said status indicator differentially depending on a relationship between said information located in at least one of said plurality of information sources or said intermediate datasource and a corresponding one of said plurality of status indicator thresholds.

28. A computer-based system for presenting an information display screen, comprising:
means for accessing a plurality of information sources, at least one of said information sources being an intermediate datasource;
means for linking said intermediate datasource to at least one additional information source;
means for generating a display screen template, said display screen template including at least one control, each said at least one control having at least one function associated therewith, said display screen template including at least one status indicator;
means for storing a display screen function database associated with said display screen template, said display screen function database containing at least one record of a function associated with a control on said display screen template, said display screen function database containing at least one record of a status indicator threshold;
means for selectively activating said status indicator based on information located in at least one of said information sources and on at least one status indicator threshold; and
means responsive to a control on said display screen template, for invoking a function associated with said control on said display screen template upon activation of said control.

29. A computer-based system for presenting an information display screen in accordance with claim 28, further comprising means for user authentication for controlling access to predetermined information sources based on user identification information.

30. A computer-based system for presenting an information display screen in accordance with claim 28, wherein said display screen template includes a display region for presenting selected information to a user upon activation of said control.

31. A computer-based system for presenting an information display screen in accordance with claim 30, further comprising means, responsive to activation of said control, for generating a three-dimensional image based on data stored in at least one of said plurality of information sources and presenting said three-dimensional image in said display region.

32. A computer-based system for presenting an information display screen in accordance with claim 31, wherein said mean for generating a three-dimensional image is capable of generating a three-dimensional image of an object having visual attributes thereof show a relationship between data stored in at least one of said plurality of information sources and at least a portion of said object.

33. A computer-based system for presenting an information display screen in accordance with claim 30, further comprising means for retrieving a three-dimensional image from one of said plurality of information sources and presenting said three-dimensional image in said display region.

34. A computer-based system for presenting an information display screen in accordance with claim 28, wherein said function is an operation selected from the group consisting of a hyperlink, a script, a program, and a query.

35. A computer-based system for presenting an information display screen in accordance with claim 28, wherein said at least one record of a function associated with a control on said display screen template contains a plurality of status indicator thresholds associated with a single status indicator, and
wherein said means for selectively activating said status indicator differentially activates said status indicator depending on a relationship between said information located in at least one of said information sources and a corresponding one of said plurality of status indicator thresholds.

36. A computer-based system for presenting an information display screen in accordance with claim 27, wherein said status indicator is capable of displaying more than two status indications.

37. A computer-based system for presenting an information display screen in accordance with claim 27, further comprising means, responsive to activation of said control, for displaying information based on information obtained from at least one of said plurality of information sources, in said display region.

38. A computer-based system for presenting an information display screen in accordance with claim 27, further comprising means, responsive to activation of said control, for displaying information based on information obtained from said intermediate datasource, in said display region.

39. A computer-based system for presenting an information display screen in accordance with claim 38, wherein said means for linking said intermediate datasource to at least one additional information source obtains information from said at least one additional information and stores said thus obtained information in said intermediate datasource.

40. A computer-based system for presenting an information display screen in accordance with claim 38, wherein said means for linking said intermediate datasource to at least one additional information source periodically obtains information from said at least one additional information and stores said thus periodically obtained information in said intermediate datasource.

41. A computer-based system for presenting an information display screen, comprising:
a computer;
an interface device adapted to connect said computer to a plurality of information sources;
a computer readable medium containing computer executable code for generating a display screen template, said display screen template including at least one control, each said at least one control having at least one function associated therewith, said display screen template including at least one status indicator, said display screen template further including a display region for presenting selected information to a user upon activation of said control;
a computer storage device for storing a display screen function database associated with said display screen template, said display screen function database containing at least one record of a function associated with a control on said display screen template, said display screen function database containing at least one record of a status indicator threshold; and
wherein said computer readable media containing computer executable code additionally includes computer executable code for:
selectively activating said status indicator based on information located in at least one of said information sources and on at least one status indicator threshold, and
responding to activation of a control on said display screen template, for generating a multi-axis scorecard display based on data stored in at least one of said plurality of information sources and presenting said scorecard display in said display region upon activation of said control.

42. A computer-based system for presenting an information display screen in accordance with claim 41, further comprising a data link for providing a link between an information source and an intermediate datasource so that information in an information source can be provided to said intermediate datasource, and
wherein said interface device is adapted to connect said computer to a plurality of information sources including an intermediate datasource.

43. A computer-based system for presenting an information display screen in accordance with claim 42, wherein said computer executable code for generating a multi-axis scorecard display is adapted to generate a multi-axis scorecard display based on data stored in at least one of said plurality of information sources and on data stored in said intermediate datasource.

44. A computer-based system for presenting an information display screen in accordance with claim 41, wherein said computer executable code for generating a multi-axis scorecard display is adapted to generate a multi-axis scorecard display based on data stored in at least two of said plurality of information sources.

45. In a computer-based system for presenting a plurality of display screens, each display screen including at least one control, each control having at least one function associated therewith, a method for generating a custom display screen comprising the steps of:
providing a plurality of display screen function databases, each display screen function database being associated with a respective one of a plurality of display screens, each display screen function database containing at least one record of a function associated with a control for said respective one of said plurality of display screens;
providing a custom display screen template having at least one undefined control;
selecting an undefined control on said custom display screen template;
receiving a first user request for specific functionality on a custom display;
identifying a first data source which relates to the first user request for specific functionality;
exporting data from said first data source into an intermediate data source;
prototyping a function which relates to the first user request for specific functionality and said intermediate data source;
associating said selected undefined control with said prototype function;
updating a display screen function database associated with said custom display screen template with a record corresponding to said prototyped function;
receiving user feedback on said prototype function;
modifying said prototype function to change a data relationship thereof from said intermediate data source to said first data source and updating said custom display screen function database associated with said custom display screen template with a record corresponding to said modified prototyped function; and
saving said display screen function database associated with said custom display screen template for production use.

46. A method for generating a custom display screen in accordance with claim 45, further comprising the steps of:
selecting a record of a function associated with a control for said respective one of said plurality of display screens from one of said plurality of display screen function databases;
selecting an undefined control on said custom display screen template;
associating said selected undefined control with said selected record of a function associated with a control; and
updating a display screen function database associated with said custom display screen template with a record corresponding to said selected record of a function.

47. A method for generating a custom display screen in accordance with claim 45, further comprising the steps of:
selecting an undefined status indicator on said custom display screen template;
associating said selected undefined status indicator with an information parameter and a threshold to define a new status indicator; and
updating a display screen function database associated with said custom display screen template with a record corresponding to a definition of said new status indicator.
